(19) United States
(12) Patent Application Publication
(10) Pub. No.: US 2002/0044549 A1
(43) Pub. Date: Apr. 18, 2002

(54) Efficient scatternet forming

(76) Inventors: Per Johansson, Hagersten (SE); Johan Rune, Lidingo (SE); Tony Larsson, Stockholm (SE); Christian Gehrmann, Stockholm (SE)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 09/876,087

(22) Filed: Jun. 8, 2001

Related U.S. Application Data
(60) Provisional application No. 60/210,908, filed on Jun. 12, 2000.

(51) Int. Cl. H04L 12/50

(52) U.S. Cl. 370/386; 370/255

(57) ABSTRACT

Two logically separated scatternets, the maximum connectivity scatternet (MCS) and the traffic scatternet (TS) are provided. An MCS maintains information about all nodes in the scatternet in order to facilitate a quick path establishment when a destination node is searched for. The MCS is maintained autonomously as new nodes arrive to the scatternet and other nodes leave the scatternet. A TS is established on a per session basis, primarily between two nodes in the scatternet. The TS is designed to achieve the best possible performance for the data flow between the involved nodes. When supported, in addition to establishing dedicated TS piconets and/or dedicated TS links, this may involve switching to the Bluetooth high speed mode on TS links. An overall scatternet may consist of one MCS and several TSs.

This application claims priority under 35 U.S.C. §119(e) to U.S. provisional application No. 60/210,908 filed Jun. 12, 2000, the entire disclosure of which is herein expressly incorporated by reference.

### BACKGROUND

The present invention relates to ad-hoc networks. More particularly, the present invention relates to routing in ad-hoc networks.

Conventional networking protocols are based on the characteristics and/or features of fixed networks. In fixed networks, the network configuration typically does not change. Although nodes can be added and removed in fixed networks, the route traveled by data packets between two nodes typically does not change. The disadvantage is that fixed networks cannot be easily reconfigured to account for increases in data traffic, also called system loading. Accordingly, when system loading increases for one node, the surrounding nodes are likely to experience increased delays in the transmission and reception of data.

In contrast to fixed networks, ad-hoc networks are dynamic. An ad-hoc network is formed when a number of nodes decide to join together to form a network. Since nodes in ad-hoc networks operate as both hosts and routers, ad-hoc networks do not require the infrastructure required by fixed networks. Accordingly, ad-hoc networking protocols are based upon the assumption that nodes may not always be located at the same physical location.

Bluetooth is an exemplary ad-hoc networking technology. Bluetooth is an open specification for wireless communication of both voice and data. It is based on a short-range, universal radio link, and it provides a mechanism to form small ad-hoc groupings of connected devices, without a fixed network infrastructure, including such devices as printers, PDAs, desktop computers, FAX machines, keyboards, joysticks, telephones or virtually any digital device. Bluetooth operates in the unlicenced 2.4 GHz Industrial-Scientific-Medical (ISM) band.

FIG. 1 illustrates a Bluetooth piconet. A piconet is a collection of digital devices, such as any of those mentioned above, connected using Bluetooth technology in an ad-hoc fashion. A piconet is initially formed with two connected devices, herein referred to as nodes. A piconet can include up to eight nodes. In each piconet, for example piconet 100, there exists one master node and one or more slave nodes. In FIG. 1 Bluetooth unit 101 is a master node and Bluetooth unit 102 is a slave node.

According to Bluetooth technology a slave node can only communicate directly with a master node. FIG. 2 illustrates a piconet with a master node 201 and a plurality of slave nodes 202-208 arranged in a star network topology. If slave node 202 wishes to communicate with slave node 206, slave node 202 would have to transmit the information it wished to communicate to master node 201. Master node 201 would then transmits the information to slave node 206. In addition to being classified as a master node and slave node, a node may be classified as an idle node. An idle node is a node which is not currently participating in a piconet.

A scatternet is formed by multiple independent and unsynchronized piconets. FIG. 3 illustrates an exemplary scatternet 300. In FIG. 3, piconet 1 includes a master node 303 and the slave nodes 301, 302 and 304; piconet 2 includes the master node 305 and the slave nodes 304, 306, 307 and 308; and piconet 3 includes the master node 309 and the slave nodes 308, 310 and 311. To implement a scatternet it is necessary to use nodes which are members of more than one piconet. Such nodes may be referred to as forwarding nodes or gateway nodes. If, for example, node 301 wishes to communicate with node 310, then nodes 304 and 308 might act as forwarding nodes by forwarding the connection between the two piconets and in particular between nodes 301 and 310. For example, node 301 transfers the information to the master node of piconet 1 node 303. Master node 303 transmits the information to forwarding node 304. Forwarding node 304 then forwards the information to master node 305, which in turn, transmits the information to forwarding node 308. Forwarding node 308 forwards the information to master node 309 which transmits the information to the destination node 310.

In order for a node to participate in more than one piconet the node enters a HOLD mode in one piconet while participating in another piconet. For example, after master node 303 forwards a packet to forwarding node 304, forwarding node 304 enters a HOLD mode with respect to piconet 1 and participates in piconet 2 so that forwarding node 304 can forward the packet to master node 305. For more information regarding HOLD modes in Bluetooth networks, the interested reader should refer to U.S. Pat. No. 6,026,297 “Contemporaneous Connectivity To Multiple Piconets” to Jaap Haartsen, the entire disclosure of which is herein expressly incorporated by reference.

Each Bluetooth unit has a globally unique 48 bit IEEE 802 address. This address, called the Bluetooth Device Address (BD_ADDR) is assigned when the Bluetooth unit is manufactured and it has never changed. In addition, the master of a piconet assigns a local active member address (AM_ADDR) to each active member of the piconet. The AM_ADDR, which is only three bits long, is dynamically assigned and deassigned and is unique only within a single piconet. The master uses the AM_ADDR when polling a slave in a piconet. However, when the slave, triggered by a packet from the master addressed with the slave's AM_ADDR, transmits a packet to the master, it includes its own AM_ADDR (not the masters) in the packet header.

Even though all data is transmitted in packets, the packets can carry both synchronous data, on Synchronous Connection Oriented (SCO) links which is mainly intended for voice traffic, and asynchronous data, on asynchronous connectionless links (ACL) links. Depending on the type of packet that is used, an acknowledgment and retransmission scheme is used (not for SCO packets transferring synchronous data) to ensure reliable data transfer, as well as forward error correction (FEC) in the form of channel coding.

FIG. 4 illustrates a conventional Bluetooth packet. The conventional Bluetooth packet consists of access code 410, header 420 and payload 430. The header 420 contains the AM_ADDR followed by some control parameters, e.g., a bit indicating acknowledgment or retransmission request of the previous packet, when applicable, and a header error check (HEC). The access code in the packet can be of three different types including a channel access code (CAC), a device access code (DAC) or an inquiry access code (IAC). [0013] The channel access code identifies a channel that is used in a particular piconet, i.e., in essence the channel access code identifies the piconet. Accordingly, all packets exchanged within a piconet carry the same channel access code. The channel access code is derived from the BD_ADDR of the master unit of the piconet. The device access code is derived from a BD ADDR of a particular Bluetooth unit. The device access code is used for special signaling procedures, e.g., the PAGE procedure. There are two types of inquiry access codes, the general inquiry access code (GIAC) and the dedicated inquiry access code (DIAC). Both the general inquiry access code and the dedicated inquiry access code are used in the INQUIRY procedure.

The format of payload 430 depends on the type of packet. The payload of an ACL packet consists of a header, a data field and a cyclic redundancy check (CRC). The payload of an SCO packet consists only of a data field. In addition, there are hybrid packets including two data fields, one for synchronous data and one for asynchronous data. Packets in which the payload does not include a CRC are neither acknowledged nor retransmitted.

Since ad-hoc networks are dynamic, ad-hoc networking technology typically has a neighbor discovery feature. The neighbor discovery feature allows one node to find any other node within radio range with which the first node can communicate with and consequently form an ad-hoc network with. A neighbor discovery procedure in Bluetooth is known as the INQUIRY procedure. Once a Bluetooth unit knows of neighboring nodes, a Bluetooth unit can connect to the neighboring node using the PAGE procedure.

FIG. 5 illustrates the signaling performed between two Bluetooth units for neighbor discovery and connection establishment. A Bluetooth unit, such as Bluetooth unit 1 wishing to discover neighboring nodes transmits an INQUIRY message. The Bluetooth unit then waits and listens for an INQUIRY RESPONSE message. An INQUIRY message consists of only an inquiry access code. The inquiry access code can be a general inquiry access code, which is sent to discover any Bluetooth unit in the neighborhood, or a dedicated inquiry access code, which is sent to discover only certain types of Bluetooth units, for which a particular dedicated inquiry access code is dedicated.

When a neighboring node, such as Bluetooth unit 2, receives an INQUIRY message the neighboring node will respond with an INQUIRY RESPONSE message. The INQUIRY RESPONSE message is really an FHS (Frequency Hop Synchronization) packet. A FHS packet is illustrated in FIG. 6. The FHS packet includes fields for parity bits, lower address part (LAP), (SR), (SP), upper address part (UAP), non-significant address part (NAP), class of service, AM_ADDR, internal value of the units clock (CLK), and Page Scan Mode. The LAP, UAP and NAP together comprise the BD_ADDR. The SR, SP and Page Scan Mode fields are control parameters used during the page procedure. The AM_ADDR field can be used to assign an AM_ADDR to a Bluetooth unit which is becoming a slave in a piconet and the undefined field is reserved for future use.

An FHS packet is also used for other purposes in a Bluetooth system, e.g., for synchronization of the frequency hop channel sequence. By listening for INQUIRY RESPONSE messages the Bluetooth unit that initiated the INQUIRY procedure, e.g., Bluetooth unit 1, can collect the BD_ADDR and internal clock values, both of which are included in the FHS packet, of the neighboring Bluetooth units.

When a Bluetooth unit desires to establish a connection with a neighboring node, the Bluetooth unit sends a PAGE message. A PAGE message consists of the Device Access Code (DAC), derived from the BD_ADDR of the paged Bluetooth unit. A Bluetooth unit, e.g., Bluetooth unit 2, receiving a PAGE message including its own DAC responds with an identical packet, i.e., a packet including only the DAC of the paged Bluetooth unit. The paging Bluetooth unit, i.e., Bluetooth unit 1, then replies with an FHS packet, including the BD_ADDR of the paging Bluetooth unit (Bluetooth unit 1), the current value of the internal clock of the paging Bluetooth unit (Bluetooth unit 1), the AM_ADDR assigned to the paged Bluetooth unit (Bluetooth unit 2) and some other parameters. The paged Bluetooth unit (Bluetooth unit 2) then responds with its DAC and thereby the connection between the two Bluetooth units is established.

If the paging Bluetooth unit already was the master of a piconet, the paged Bluetooth unit has now joined this piconet as a new slave unit. Otherwise, the two Bluetooth units have just formed a new piconet with the paging Bluetooth unit as the master unit. Since the INQUIRY message does not include any information about its sender, in particular not its BD_ADDR, the Bluetooth unit that initiated the INQUIRY procedure is the only one that can initiate a subsequent PAGE procedure. Thus, the Bluetooth unit initiating an INQUIRY procedure will also be the master of any piconet that is formed as a result of a subsequent PAGE procedure. However, if considered necessary, the roles of master and slave can be switched using a master-slave-switch mechanism in Bluetooth. This, however, is a complex and extensive procedure potentially resulting in a redefinition of the entire piconet and involving all other slave units in the piconet.

In addition to the regular communication in a Bluetooth piconet the Bluetooth Special Interest Group is developing a high speed mode to be used when higher data rates are desired. In this mode the data rate is increased up to around 11 Mbits per second. In the high speed mode the polling based communication of the regular Bluetooth communication is replaced by a token-passing scheme, in which a token, representing the right to transmit on the high speed channel, is passed along with the data packets of the high speed mode. The high speed communication takes place in a sort of “sub-piconet”, in which only devices supporting the high speed mode can take part. Hence, a master node abandons its detailed control of the communication for slave nodes in the high speed mode. However, a master node still maintains the control of the initiation of a high speed “sub-piconet” and of which nodes join a high speed “sub-piconet”.

Within the high speed “sub-piconet” the communicating nodes are no longer limited to communicating directly with the master node. Instead high speed packets can be sent to any node that has joined the high speed “sub-piconet” regardless of the node's status as master or slave. However, nodes belonging to different piconets cannot take part in the same high speed “sub-piconet”, unless they first establish or join a common piconet in which a high speed “sub-piconet” can be initiated. This also means that if two nodes which do not belong to the same piconet wish to establish high speed communication, they first have to use the regular PAGE procedure, possibly preceded by the INQUIRY procedure in order to establish a common piconet or join a common piconet. There is no special “high-speed-mode-PAGE” procedure which can be used to establish high speed communication without first establishing the regular Bluetooth mode. Accordingly, the initial formation of a Bluetooth piconet and scatternet, is based on a minimum of information. In conventional networking schemes a link is assumed to always or already exist between any two nodes within radio range of each other in the ad-hoc network. However, according to Bluetooth, connection establishment procedures, such as INQUIRY and PAGE procedures, must be performed to establish the connections between nodes which are within radio range of each other. Once these connections are established between the nodes in a Bluetooth network conventional routing schemes can be implemented. Accordingly, it would be desirable integrate piconet/scatternet establishment with traffic path establishment in order to form efficient scatternet and traffic path structures.

When communication is established between two nodes in a network, two phases with different objectives in terms of network characteristics can be distinguished. First, the destination node for which the source node is looking for should be located in the same network and a path to reach the destination node should be determined. This requires either the network nodes to maintain some overall information about every node in the network, or that a global search for the destination node be initiated. Second, once the destination node is found and the data exchange has started, the communication path found during the establishment procedure should provide the best possible performance in terms of delay and throughput.

Accordingly, it would be desirable to provide mechanisms for satisfying the two phases of communication establishment in an ad-hoc network. Specifically, it would be desirable to provide such mechanisms in ad-hoc networks in which limited information is exchanged during link establishment, such as Bluetooth networks.

### SUMMARY

These and other problems, drawbacks and limitations of conventional techniques are overcome according to the present invention.

The present invention satisfies the two phases of communication establishment in scatternet forming by providing two logically separated scatternets, the maximum connectivity scatternet (MCS) and the traffic scatternet (TS). An MCS maintains information about all nodes in the scatternet in order to facilitate a quick path establishment when a destination node is searched for. The MCS is maintained autonomously as new nodes arrive to the scatternet and other nodes leave the scatternet. A TS is established on a per session basis, primarily between two nodes in the scatternet. The objective of the TS is to achieve the best possible performance for the data flow between the involved nodes. When supported, in addition to establishing dedicated TS piconets and/or dedicated TS links, this may involve switching to the Bluetooth high speed mode on TS links. Information to coordinate and facilitate the establishment of a TS is generally provided through the MCS. The nodes which are members of a TS are also members the MCS and possibly are also members of other TSs. Accordingly, an overall scatternet may consist of one MCS and several TSs.

### BRIEF DESCRIPTION OF THE DRAWINGS

The objects and advantages of the invention will be understood by reading the following detailed description in conjunction with the drawings in which:

FIG. 1 illustrates an exemplary piconet;

FIG. 2 illustrates an exemplary star-topology network;

FIG. 3 illustrates an exemplary scatternet formed by a plurality of piconets;

FIG. 4 illustrates a conventional Bluetooth packet;

FIG. 5 illustrates signalling between two nodes for neighbor discovery and connection establishment;

FIG. 6 illustrates a conventional FHS packet;

FIG. 7 illustrates an exemplary scatternet which includes maximum connectivity scatternets and traffic scatternets in accordance with the present invention;

FIG. 8 illustrates an exemplary piconet information database record in accordance with the present invention;

FIGS. 9A-9C illustrate maximum connectivity scatternet establishment procedures for an idle node;

FIG. 10 illustrates maximum connectivity scatternet establishment procedures for a slave node in accordance with the present invention;

FIG. 11 illustrates maximum connectivity scatternet establishment procedures for a master node in accordance with exemplary embodiments of the present invention;

FIG. 12 illustrates maximum connectivity scatternet maintenance procedures in accordance with the present invention;

FIG. 13 illustrates traffic scatternet establishment procedures in accordance with the present invention;

FIG. 14 illustrates a method for evaluating a traffic scatternet candidate node in accordance with the present invention;

FIG. 15 illustrates an exemplary traffic scatternet in accordance with the present invention;

FIG. 16 illustrates a method for traffic scatternet candidate chain building in a start node in accordance with the present invention;

FIGS. 17A and 17B illustrate traffic scatternet candidate chain building in a first intermediate node in accordance with the present invention;

FIGS. 18A-18C illustrate three different methods for traffic scatternet candidate chain building in subsequent intermediate nodes in accordance with the present invention;

FIG. 19 illustrates the building of a chain of candidate nodes in accordance with the present invention;

FIG. 20 illustrates traffic scatternet candidate chain building in an end node in accordance with the present invention;

FIG. 21 illustrates an exemplary method for confirmation phase in an end node in accordance with the present invention;

FIG. 22 illustrates confirmation in an intermediate node in accordance with the present invention;

FIG. 23 illustrates confirmation in a start node in accordance with the present invention; FIG. 24 illustrates a paging phase in accordance with the present invention;

FIGS. 25A-25C illustrate a traffic scatternet tree building in accordance with the present invention;

FIG. 26 illustrates a traffic scatternet candidate tree building in a start node in accordance with the present invention;

FIGS. 27A and 27B illustrate a traffic scatternet candidate tree building in an intermediate node in accordance with the present invention;

FIG. 28 illustrates a traffic scatternet candidate tree building in subsequent intermediate nodes in accordance with the present invention;

FIG. 29 illustrates a traffic scatternet candidate tree building in an end node in accordance with the present invention;

FIG. 30 illustrates confirmation and PAGE synchronization phase for a traffic scatternet tree in accordance with the present invention;

FIG. 31 illustrates an exemplary method for paging in accordance with the present invention;

FIGS. 32A-32C illustrates methods for traffic scatternet establishment in a network where reachability information is not available in accordance with the present invention;

FIG. 33 illustrates an exemplary maximum connectivity scatternet in accordance with the present invention; and

FIG. 34 illustrates an exemplary reachability chain in accordance with the present invention.

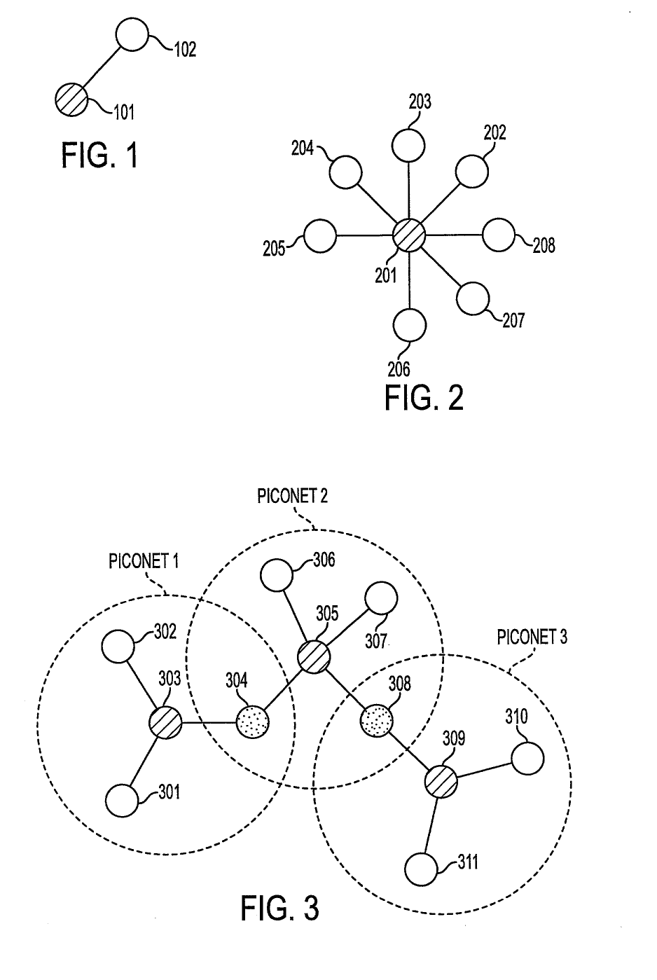

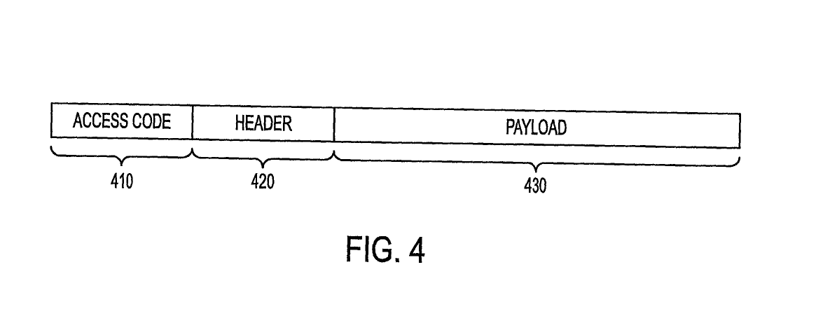

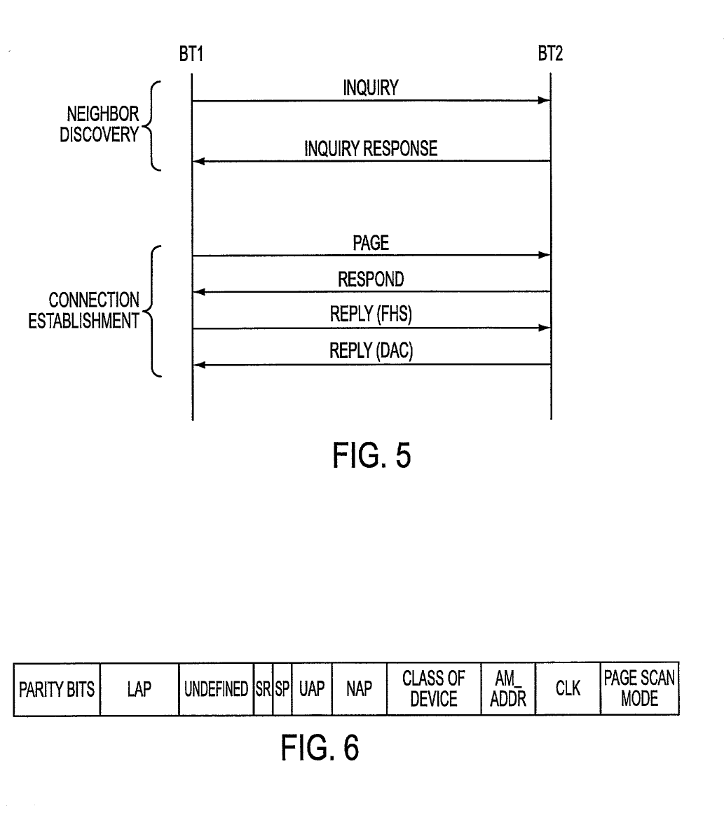

### DETAILED DESCRIPTION

In the following description, for purposes of explanation and not limitation, specific details are set forth in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention.

Overview

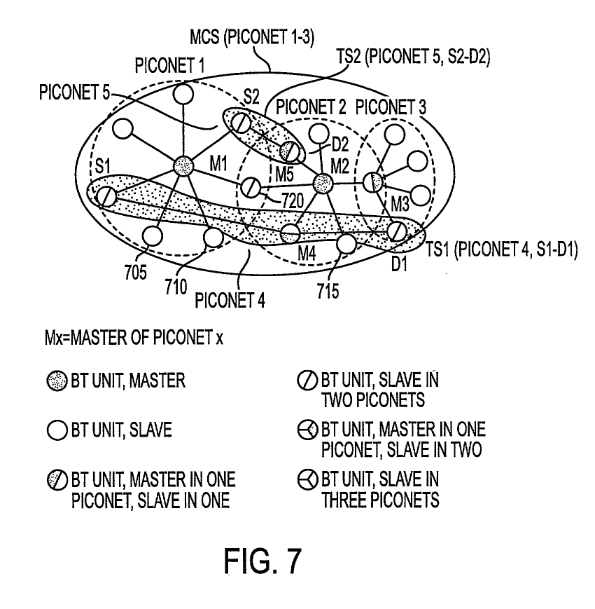

FIG. 7 illustrates an exemplary scatternet with one maximum connectivity scatternet (MCS) and two traffic scatternets (TS). The MCS includes Piconets 1-3. Piconet 1 includes a master node M1 and seven slave nodes; Piconet 2 includes master node M2 and six slave nodes; and Piconet 3 includes master node M3 and five slave nodes. The objective of an MCS is to maximize the number of nodes in each piconet in order to spread and maintain information with as few inter-piconet connections as possible, i.e., to minimize the number of forwarding nodes. An MCS can be thought of as an efficient scatternet. Unlike conventional scatternets, an MCS contains information about all of the nodes in the scatternet. This allows for quick path establishment when a search for a destination node is performed. The master of each piconet in the MCS keeps a record of each slave in the piconet stored in a piconet information database.

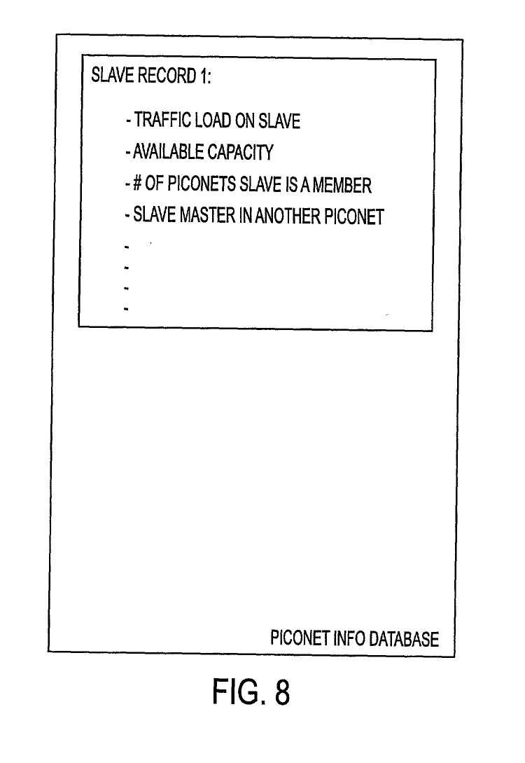

FIG. 8 illustrates an exemplary piconet information database. As illustrated in FIG. 8, a slave record may contain information regarding the traffic load on the slave node, its available capacity, the number of piconets the slave node is a member of, if the slave node is also a master node in another piconet, etc. The piconet information database may be shared among some of the members of the piconet, e.g., stored by all gateway (forwarding) slave nodes in order to provide fast feedback to requests received by neighbor piconets.

A TS is established on a per session basis, primarily between two nodes in the scatternet. These nodes will also be members of the MCS, and possibly also be members of other TSs. Thus, an overall scatternet may consist of one MCS and several TSs. A TS is designed to achieve the best possible performance for the data flow between the involved nodes, i.e., the sending and receiving nodes. In accordance with the present invention, information to coordinate and facilitate the establishment of a TS is generally provided through the MCS. The MCS illustrated in FIG. 7 includes piconets 1-5. Piconets 1-3 are conventional piconets, while piconets 4 and 5 are Tss.

It may be very difficult to predict the duration and bandwidth requirements posed by a communication session. The approach used herein is to begin a communication session using the MCS and then immediately start the TS establishment procedure. The nodes involved in the TS establishment can be coordinated through the MCS to facilitate the setup, e.g., PAGE and PAGE Scan can be synchronized. User data may be piggybacked on the TS control messages in the MCS to multiplex the control and data information flows. As soon as the TS is established, the traffic stream is moved over to the links of the TS. Alternatively, the TS establishment is delayed for a period of time to avoid a TS setup for a very short-lived session, e.g. a single packet inquiry and response exchange. However if the same short session is repeated often it may still be of value to have a TS for the source and destination(s) of the session.

The TS may also be a way of mapping an IP multicast group onto the Bluetooth scatternet structure. Hence, the nodes being members of the multicast group are included in the TS and are thereby logically separated from the MCS and other TS's. Note that it may be that not all the members of such a multicast TS are members of the IP multicast group since (non-member) intermediate nodes may be necessary in the TS to reach all the multicast members.

Maximum Connectivity Scatternet

To establish an efficient scatternet, such as an MCS, the nodes should interconnect in a controlled manner to avoid structures that are densely connected. For instance, the number of interconnections between two adjacent piconets should be kept to a minimum, e.g., on the order of 1 to 2, to limit the number of interpiconet (forwarding) nodes. Further, a network ID, such as a scatternet ID, can be used by a node to determine if another detected node is part of the same scatternet or not. The scatternet ID may be stored in the piconet information database of the piconets of the scatternet. When scatternets merge, a common scatternet ID must be decided upon. For more information regarding a scatternet ID, the interested reader should refer to U.S. patent application No. 09/709,643 “Random Identity Management In Scatternets” to Johan Rune filed Nov. 13, 2000, which is herein expressly incorporated by reference.

In addition, due to the ad-hoc behavior of scatternets, the method for forming an MCS should not rely on a centralized mechanism above the master of a piconet.

Prior to a detailed description of the behavior of the various nodes in the MCS establishment procedure, a brief description of the overall operation and interrelation of the nodes is presented below. Each node may maintain a variable corresponding to the number of other nodes that it can reach directly, i.e., within one hop, and a list of all the BD_ADDRs it has heard. This variable and the list are maintained through the INQUIRY procedure, where a node obtains the BD_ADDRs from the nodes that it can hear directly. For example, referring again to FIG. 7, assume that node M4 can hear nodes SI, 705, 710, 715, 720, M2 and D1. Accordingly, node M4 will store a value of 7 for the number of nodes that node M4 can hear and the nodes' corresponding BD_ADDRs. It will be recognized that although node M4 can hear nodes 705, 710, 715 and 720 there are no links connecting node M4 and nodes 705, 710, 715 and 720 because the piconets were formed such that there exists no links between these nodes.

In order to detect new nodes and adapt to new connectivity conditions due to mobility or obstacles, the INQUIRY process should be invoked by every node periodically. It can be expected that the INQUIRY frequency is highest for idle nodes, lower for slave nodes and lowest for master nodes in an MCS. However, in order to limit the INQUIRY intensity in a dense scatternet, the nodes may decrease their INQUIRY frequency as the number of detected nodes increases. This allows the scatternet to maintain a constant INQUIRY rate independent of the number of nodes.

In the following procedure descriptions several of the functions proposed in U.S. patent application No. 09/729,926 “Intelligent Piconet Forming” by Johan Rune filed on Dec. 6, 2000, are utilized. The entire disclosure of the “Intelligent Piconet Forming” application is herein expressly incorporated by reference. In particular, the feature that the information about whether a node responding to an INQUIRY message is a master or a slave or an idle node is included in the INQUIRY RESPONSE message (preferably coded in the two undefined bits of the FHS packet, as suggested in “Intelligent Piconet Forming”). Another feature from “Intelligent Piconet Forming” that is used is that a node responding to an INQUIRY message can include the number of slaves in its piconet in the INQUIRY RESPONSE message (provided that the responding node is not idle) using the AM_ADDR field, which, according to the current standard, is not used (and should be set to all zeros) when the FHS packet is used as an INQUIRY RESPONSE message. In addition to the features described in “Intelligent Piconet Forming” it is proposed to let an idle node include the number of other nodes that it can reach (e.g., detected through INQUIRY procedures) in the INQUIRY RESPONSE message. The AM_ADDR field would be used also for this information. The fact that the responding node's status as idle, master or slave is indicated in the INQUIRY RESPONSE message allows the inquiring node to correctly interpret the contents of the AM_ADDR as either number of slave nodes in the responding node's piconet or the number of nodes that the responding nodes can reach. In the latter case, if the responding idle node can reach more than seven other nodes, it will still report only seven reachable nodes, since the AM_ADDR field, being only three bits long, cannot represent a number greater than seven.

Idle Node Procedures

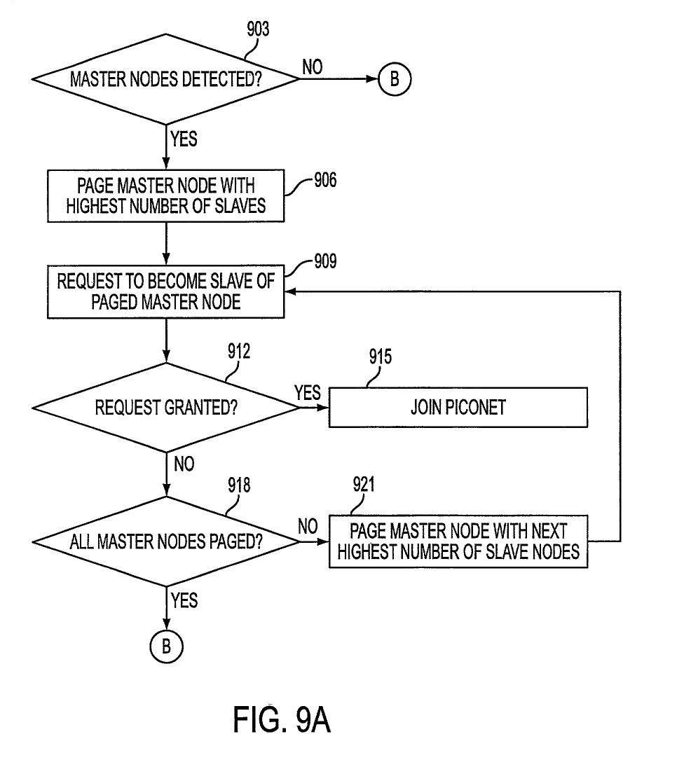

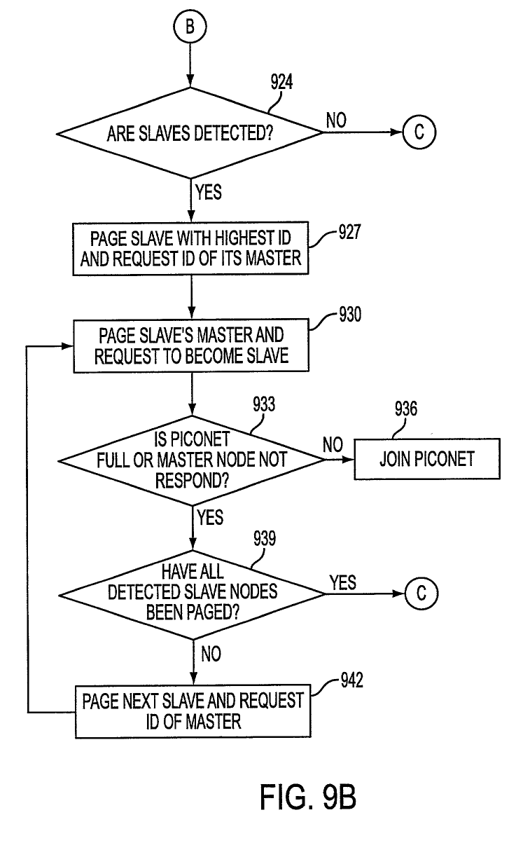

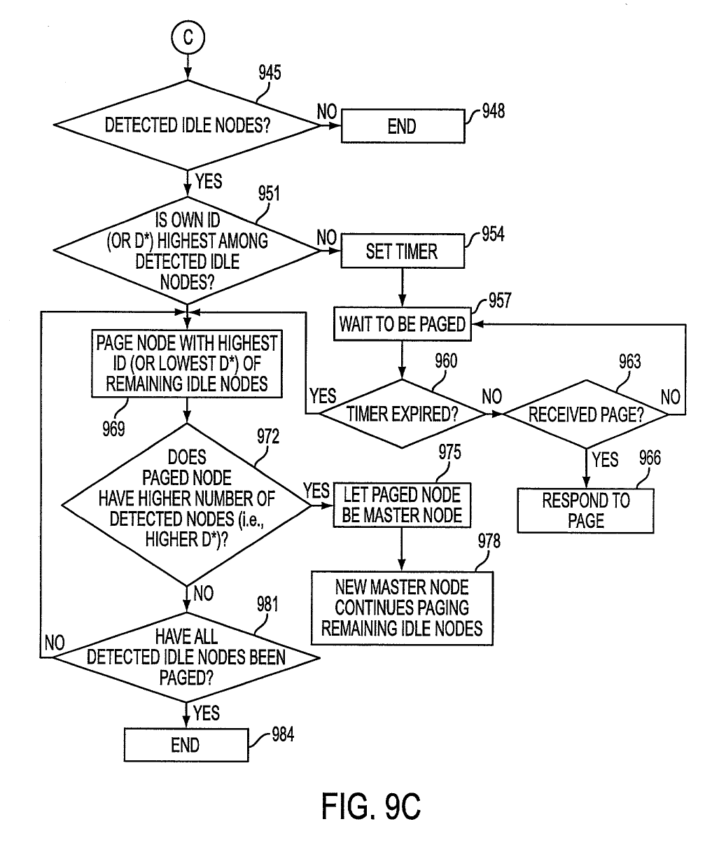

FIGS. 9A-9C illustrate MCS establishment procedures for idle nodes. Initially, an idle node determines whether there are any master nodes detected (step 903). In accordance with exemplary embodiments of the present invention the status of detected nodes, i.e., whether a node is idle, a master or a slave can be provided in a modified FHS packet. Further, to avoid a burst of PAGE messages from idle nodes to obtain the status information, idle nodes will perform PAGE procedures in order based upon the idle nodes' BD_ADDR. Alternatively, the idle nodes can perform the PAGE procedure in order based upon the greatest number of detected nodes. If no master nodes are detected (“No” path out of decision step 903) then the idle node determines whether there are any slave nodes detected (step 924). If, however, master nodes are detected by the idle node (“Yes” path out of decision step 903) then the idle node pages the master node with the highest number of slaves associated with it (step 906). The idle node then requests to become a slave of the paged master node (step 909). If the idle node's request is granted (“Yes” path out of decision step 912) then the idle node joins the piconet of the master node (step 915). If the idle node's request is not granted (“No” path out of decision step 912) then the idle node determines whether all master nodes have been paged (step 918). If not all master nodes have been paged (“No” path out of decision step 918) then the idle node pages the master node with the next highest number of slave nodes (step 921) and the idle node requests to become a slave of the paged master node (step 909). The idle node continues to page master nodes and continues to request to become a slave of the master node until either the request is granted (“Yes” path out of decision step 912) or all master nodes have been paged (“Yes” path out of decision step 918).

If all master nodes have been paged (“Yes” path out of decision step 918) or no master nodes were detected (“No” path out of decision step 903) then the idle node determines whether there are any slave nodes detected (step 924). If the idle node has not detected any slave nodes (“No” path out of decision step 924) then the idle node determines whether there are other idle nodes detected (step 945). If, however, the idle node has determined that there are other slave nodes detected (“Yes” path out of decision step 924) then the idle node pages the slave with the highest ID, e.g., the highest BD_ADDR, and requests the ID of the slave node's master node (step 927). The idle node then pages the slave node's master node and requests to become a slave of the paged master node (step 930).

The idle node then determines whether the piconet is full or the master node has not responded (step 933). If the piconet is not full or the master node has responded (“No” path out of decision step 933) then the idle node joins the piconet (step 936). If the piconet is full or the master node has not responded (“Yes” path out of decision step 933) then the idle node determines whether all of the detected slave nodes have been paged (step 939). If not all of the detected slave nodes have been paged (“No” path out of decision step 939) then the idle node pages the slave node with the next highest ID and requests the ID of the master of the slave node (step 942). The idle node then continues to request to become a slave of the paged slave node's master until either the idle node has joined the piconet (step 936) or the idle node has paged all of the detected slave nodes (“Yes” path out of decision step 939).

If the idle node has paged all of the detected slave nodes (“Yes” path out of decision step 939) or the idle node has not detected any slave nodes (“No” path out of decision step 924) then the idle node determines whether it has detected any other idle nodes (step 945). If the idle node has not detected any other idle nodes (“No” path out of decision step 945) then the idle node has completed its processing for the MCS establishment procedure (step 948).

If the idle node has detected other idle nodes (“Yes” path out of decision step 945) then the idle node determines whether its own ID or the number of detected nodes (D) is the highest among the detected idle nodes (step 951). If the idle node's own ID or the number of nodes detected by the idle node (D) is not the highest among all detected idle nodes (“No” path out of decision step 951) then the idle node sets a timer (step 954) and waits to be paged (step 957). While waiting to be paged the idle node determines whether the timer has expired (step 960). If the timer has not expired (“No” path out of decision step 960) then the idle node determines whether it had received a page (step 963). If the idle node has received a page (“Yes” path out of decision step 963) then the idle node will respond to the page (step 966). If the idle node has not received a page (“No” path out of decision step 963) then the idle node continues to wait to be paged (step 957) until either the timer has expired (“Yes” path out of decision step 960) or the idle node has received a page (“Yes” path out of decision step 963).

If the idle node's own ID or the number of nodes detected by the idle node (D) is highest among all detected idle nodes (“Yes” path out of decision step 951) or the timer has expired (“Yes” path out of decision step 960) then the idle node pages the node with the highest ID or lowest number of detected nodes (D) of the remaining idle nodes (step 969). The idle node then determines whether the paged node has a higher number of detected nodes (D) than the idle node (step 972). If the paged node has a higher number of detected nodes (D) (“Yes” path out of decision step 972) then the idle node lets the paged node become a master node (step 975). The new master node, i.e., the paged node, then continues paging the remaining idle nodes (step 978). If, however, the paged node does not have a higher number of detected nodes (D) than the idle node (“No” path out of decision step 972) then the idle node determines whether all detected idle nodes have been paged (step 981). If not all detected idle nodes have been paged (“No” path out of decision step 981) then the idle node continues to page the remaining idle nodes in order of idle node with the highest ID or lowest number of detected nodes (D) until the idle node has paged a node with a higher number of detected nodes (D) (“Yes” path out of decision step 972) or until all of the detected idle nodes have been paged (“Yes” path out of decision step 981). If all of the detected idle nodes have been paged (“Yes” path out of decision step 981) then the processing for the idle node with regard to MCS establishment procedures ends (step 984).

Slave Node Procedures

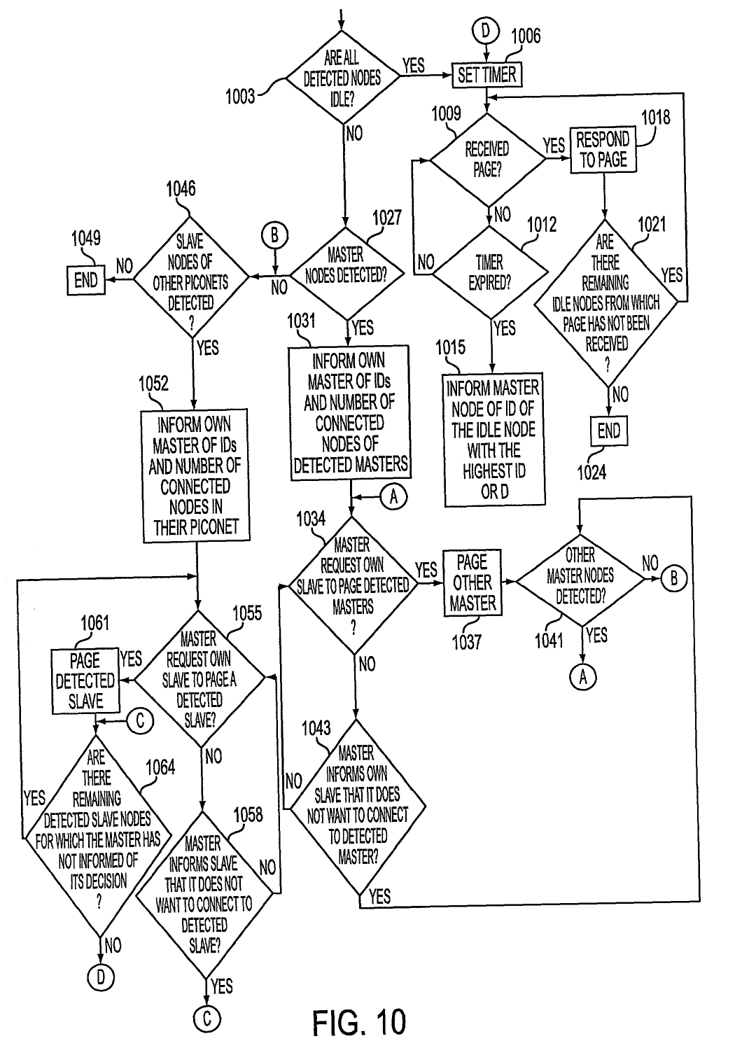

FIG. 10 illustrates MCS establishment procedures for a slave node in accordance with exemplary embodiments of the present invention. Initially, the slave node determines whether all of the detected nodes are idle (step 1003). If all of the nodes detected by the slave node are idle (“Yes” path out of decision step 1003) then the slave node sets a timer (step 1006). The slave node then determines whether it has received a page (step 1009). If the slave node has not received a page (“No” path out of decision step 1009) then the slave node determines whether the timer has expired (step 1012). If the timer has not expired (“No” path out of decision step 1012) then the slave node continues to determine whether it has received a page (step 1009). If, however, the slave node has determined that the timer has expired (“Yes” path out of decision step 1012) then the slave node informs the master node of the ID of the idle node with the highest ID or the highest number of detected nodes (D) (step 1015).

If the slave node has received a page before the expiration of the timer (“Yes” path out of decision step 1009) then the slave node will respond to the page (step 1018). The slave node then determines whether there are any remaining idle nodes from which a page has not been received (step 1021). If the slave node determines that it has received a page from all remaining idle nodes (“No” path out of decision step 1021) then the slave node's (D) processing for the MCS establishment procedure has ended (step 1024). If the slave node determines that there are remaining idle nodes from which the slave node has not received a page (“Yes” path out of decision step 1021) then the slave node continues to determine whether it has received a page from the paged idle node (step 1009).

If not all of the nodes detected by the slave node are idle nodes (“No” path out of decision step 1003) then the slave node determines whether it has detected any master nodes (step 1027). If the slave node has detected master nodes (“Yes” path out of decision step 1027) then the slave node informs its own master of the IDs and the number of connected nodes (D) of the detected master nodes (step 1031). The slave node then determines whether its master node has requested it to page the detected master nodes (step 1034). If the slave node has been requested to page the detected master nodes (“Yes” path out of decision step 1034) then the slave node pages the other master nodes (step 1037). The slave node then determines whether it has detected any other master nodes (step 1041). If the slave node has determined that there are no other master nodes detected (“No” path out of decision step 1041) then the slave node determines whether there are slave nodes of other piconets detected (step 1046). If the slave node determines that other master nodes have been detected (“Yes” path out of decision step 1041) then the slave node determines whether its master node has requested it to page detected master nodes (step 1034).

If the slave node determines that the master node has not requested the slave node to page the detected master nodes (“No” path out of decision step 1034) then the slave node determines whether the master node has informed it that the master node does not want the slave node to connect to the detected master nodes (step 1043). If the slave node has not been informed by the master node that it does not want it to connect to a detected master node (“No” path out of decision step 1043) then the slave node continues to determine whether the master node has requested it to page the detected master nodes (step 1034). If the slave node has been informed by its master node that it does not want the slave node to connect to any detected master nodes (“Yes” path out of decision step 1043) then the slave node determines whether there are other master nodes detected (step 1041) and processing proceeds as described above.

If the slave node has determined that it has not detected slave nodes of other piconets (“No” path out of decision step 1046) then the processing for the slave node in the MCS establishment procedure has ended (step 1049). If the slave node has determined that it has detected slave nodes of other piconets (“Yes” path out of decision step 1046) then the slave node informs its own master of the IDs and number of connected nodes in the piconets of the detected slaves (step 1052). The slave node then determines whether its master has requested it to page one of the detected slave nodes (step 1055). If the slave node has determined that it has not been requested by its own master to page one of the detected slave nodes (“No” path out of decision step 1055) then the slave node determines whether the master node has informed the slave node that it does not want to connect to a detected slave (step 1058).

If the slave node determines that it has not been informed by the master node that the master node does not want it to connect to a detected slave node (“No” path out of decision step 1058) then the slave node determines whether the master node had requested it to page one of the detected slave nodes (step 1055). If, however, the slave node determines that the master node has informed it that it does not want the slave node to connect to one of the detected slave nodes (“Yes” path out of decision step 1058) then the slave node determines whether there are any remaining detected slave nodes for which the master node has not informed the slave node of its decision (step 1064), i.e., whether there are remaining detected slave nodes for which the master has not informed the slave node either not to page or to page.

If the slave node determines that the master node has requested it to page a detected slave node (“Yes” path out of decision step 1055) then the slave node will page the detected slave (step 1061). The slave node then determines whether there are any remaining detected slave nodes for which the master node has not informed the slave node of whether the master node wishes the slave node to page one of the detected slave nodes (step 1064). If the slave node determines that there are no remaining detected slave nodes for which the master node has not informed the slave node of its decision (“No” path out of decision step 1064) then the slave node sets a timer (step 1006) and processing proceeds as described above. If the slave node determines that there are remaining detected slave nodes for which the master node has not informed the slave node of whether it wishes the slave node to page (“Yes” path out of decision step 1064) then the slave node determines whether the master node has requested it to page a detected slave node (step 1055) and processing proceeds as described above.

Master Node Procedures

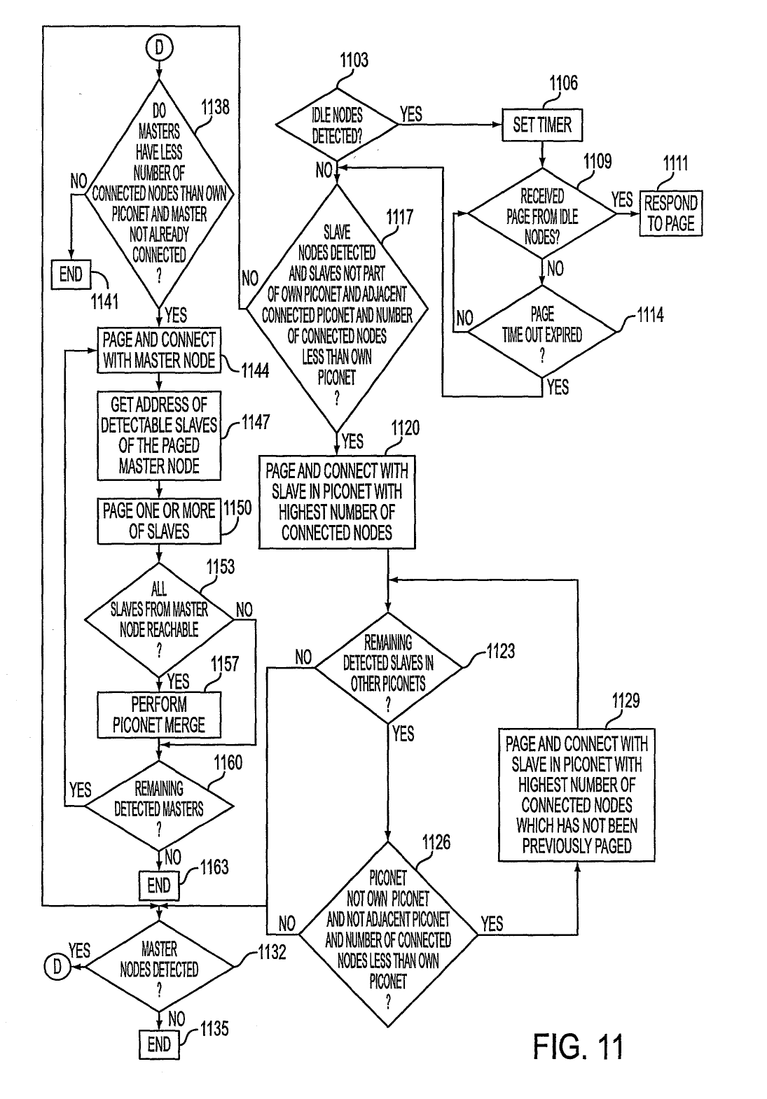

FIG. 11 illustrates an exemplary method for MCS establishment in a master node. The master node initially determines whether it has detected any idle nodes (step 1103). If the master node has detected idle nodes (“Yes” path out of decision step 1103) then the master node sets a timer (step 1106). The master node then determines whether it has received a page from any idle nodes (step 1109). If the master node determines that it has received a page from idle nodes (“Yes” path out of decision step 1109) then the master node will respond to the page (step 1111). If the master node determines that it has not received a page from idle nodes (“No” path out of decision step 1109) then the master node determines whether the page time out has expired (step 1114). If the master node determines that the page time out has not expired (“No” path out of decision step 1114) then the master node continues to determine whether it has received a page from the idle nodes (step 1109).

If the master node determines that the page time out has expired (“Yes” path out of decision step 1114) or the master node determines that no idle nodes have been detected (“No” path out of decision step 1103) then the master node determines whether it has detected any slave nodes and whether the detected slave nodes are not part of the master node's own piconet or any adjacent connected piconet and that the number of connected nodes in the slave node's piconet is less than the master node's own piconet (step 1117). If the master node has detected slave nodes which are not part of its own piconet or an adjacent connected piconet and the slave node's piconet has less connected nodes than the master node's own piconet (“Yes” path out of decision step 1117) then the master node pages and connects with the detected slave which is associated with a piconet with the highest number of connected nodes (step 1120). The master node then determines whether there are any remaining detected slaves in other piconets which have not previously been paged (step 1123).

If the master node determines that there are remaining detected slave nodes in other piconets which have not previously been paged (“Yes” path out of decision step 1123) then the master node determines whether the piconet associated with the slave node is not the master node's own piconet and is not an adjacent piconet of the master node's piconet and that the number of connected nodes in the detected slave node's piconet is less than the master node's own piconet (step 1126). If the piconet associated with the detected slave node is not in the master node's own piconet and is not in an adjacent piconet and the number of connected nodes of the slave node's piconet is less than the master node's own piconet (“Yes” path out of decision step 1126) then the master node will page and connect with the detected slave in the piconet with the highest number of connected nodes which has not previously been paged (step 1129). The master node will then continue to determine whether there are any remaining detected slave nodes in other piconets (step 1123).

If the master node determines that there are no remaining detected slave nodes in other piconets (“No” path out of decision step 1123), that the detected slave nodes are members of the master node's own piconet, or members of an adjacent piconet, or the number of connected nodes is more than the master node's own piconet (“No” path out of decision step 1126), or if the master node has not detected slave nodes, or if the detected slave nodes are part of the master node's own piconet and the number of connected nodes is not less than the number of connected nodes in the master node's own piconet (“No” path out of decision step 1117), then the master node determines whether it has detected any other master nodes (step 1132). If the master node determines that it has not detected any other master nodes (“No” path out of decision step 1132) then the master node has completed its processing for the MCS establishment procedure (step 1135).

If the master node determines that it has detected other master nodes (“Yes” path out of decision step 1132) then the master node determines whether the detected master nodes have less number of connected nodes than the master node's own piconet and the detected master nodes are not already connected to the master node's own piconet (step 1138). If the master node determines that the detected master nodes have more nodes connected in their piconet than the master node's own piconet or the detected master node is already connected to the master node's own piconet (“No” path out of decision step 1138) then the master node has completed its processing for the MCS establishment procedure (step 1141).

If the detected master nodes have less nodes connected in their piconet than the master node's own piconet and the detected master node is not already connected to the master node's own piconet (“Yes” path out of decision step 1138) then the master node will page and connect with the detected master node with the highest number of connected nodes (step 1144). The master node then gets the address of all detectable slave nodes of the paged master node (step 1147). The master node may obtain the address of all detectable slave nodes using the piconet information database described above in connection with FIG. 8. The master node then pages one or more of the detectable slave nodes (step 1150) and determines whether all slaves of the paged master node are reachable from the master node (step 1153). The master node will determine whether all slaves are reachable by comparing the number of PAGE messages sent with the number of responses received.

If all slaves of the paged master node are reachable (“Yes” path out of decision step 1153) then the master node performs a piconet merge with the piconet of the paged master node (step 1157). It will be recognized that in Bluetooth networks a master node can only host up to seven active slave nodes. Accordingly, if the master node is already hosting seven active slaves, the master node will skip step 1157 and proceed directly to step 1160. If not all of the slave nodes of the paged master node are reachable (“No” path out of decision step 1153) or after the master node has performed the piconet merge (step 1157) the master node determines whether there are any remaining detected nodes which have not yet been paged (step 1160). If the master node determines there are remaining detected master nodes which have not yet been paged (“Yes” path out of decision step 1160) then the master node will page and connect with one of the remaining detected master nodes based upon the master node with the highest number of connected nodes which has not previously been paged (step 1144) and processing proceeds as described above. If the master node determines there are no remaining detected master nodes which have not already been paged (“No” path out of decision step 1160) then the master node's processing for the MCS establishment procedure has ended (step 1163). Since the MCS is intended to group as many nodes within a particular piconet, the purpose of steps 1144-1160 is to group the maximum number of active slaves allowable, which in a Bluetooth network is seven active slaves.

MCS Maintenance Procedures

The distributed and ad-hoc behaviour of the Bluetooth nodes during the INQUIRY/PAGE procedures will most likely introduce a random structure of the initial piconet/scatternets that are formed, e.g., the node best suited as master did not perform INQUIRY/INQUIRY scan in the right moment and another node made the initial PAGE. However, an initially mis-formed MCS corresponds to the MCS resulting after any topology change in an optimal MCS. To be able to correct a mis-formed MCS, a continuous MCS maintenance process will be running in the MCS nodes. The MCS maintenance procedures perform rearrangements of master nodes and slave nodes to find the optimal MCS for the current connectivity conditions. Thus, the functions to initially form piconets or attach nodes to existing piconets are mainly intended to create an approximation of an optimal MCS, given the limited information and random node behaviour. Since the structure of ad-hoc networks may change over time, it would be desirable to continue to maintain an MCS after the MCS has been established, e.g., in accordance with the methods described in connection with FIGS. 9-11.

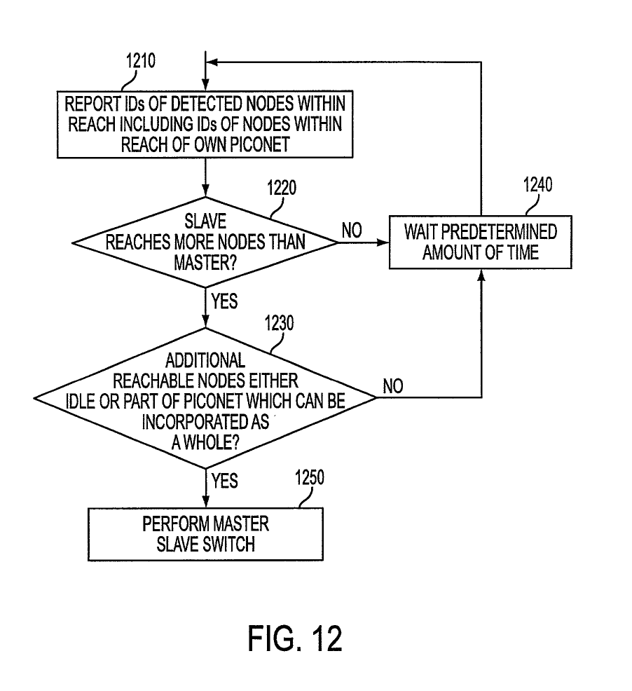

FIG. 12 illustrates an exemplary method for maintaining an MCS. Within each piconet the slaves report the IDs of the detected nodes within reach, including the IDs of nodes which are within the reporting node's own piconet (step 1210). The master node determines whether the slave node reaches more nodes than the master node (step 1220). If the slave node does not reach more nodes than the master node (“No” path out of decision step 1220) then the slave node waits a predetermined amount of time (step 1240). After waiting the predetermined amount of time, the slave node within each piconet will report the IDs of the detected nodes within reach (step 1210) and processing proceeds as described above.

If the master node determines that the slave node reaches more nodes than the master node (“Yes” path out of decision step 1220) then the master node determines whether there are additional reachable nodes that are either idle nodes or part of a piconet which can be incorporated as a whole into the master's own piconet (step 1230). If the master node determines there are not additional reachable nodes (“No” path out of decision step 1230) then the master node waits a predetermined amount of time (step 1240) and processing proceeds as described above. If, however, the master node determines there are additional reachable nodes (“Yes” path out of decision step 1230) then the master and the slave node perform a master slave switch such that the slave node now becomes the master of the piconet (step 1250).

In addition to the master nodes and slave nodes exchanging information for MCS maintenance, the master nodes of each piconet can exchange other information between each other. For example, the master nodes can exchange information regarding the number of nodes and the IDs (BD_ADDR) of the nodes in each piconet. Each master node can store this information in the piconet information database. However, in order to limit the amount of traffic, only a subset of the piconet information database contents should be exchanged between the piconets. Based on the information exchanged between the master nodes, a master node can determine if it and another master node reach an overlap of nodes. If the master node does determine that it reaches an overlap of nodes with another master, the master nodes may perform a piconet merge in order to minimize the number of inter-piconet nodes, such as MCS gateway nodes i.e., forwarding nodes between MCSs. It will be recognized that the terms gateway nodes and forwarding nodes were previously used in a generic sense. When these terms are used in a generic sense herein they refer to nodes which are members of more than one piconet. When these terms are qualified, such as an MCS gateway node or MCS forwarding node, this is intended to signify the node's role in the MCS. Likewise, the term TS gateway or TS forwarding node is intended to signify a node's role in aTS.

In addition, MCS piconets may also move some of the nodes from a fall piconet to a less occupied piconet in order to let the less occupied piconet incorporate more of the nodes, or to incorporate more nodes into piconets within the less occupied node's reach. Moving nodes from a full piconet to a less occupied piconet allows the master of the previously full piconet to take on more slave nodes. Accordingly, this will be performed when the slave nodes to be moved are within radio range of the master node of both piconets and the master node of the full piconet detects slave nodes which are within its radio range, but not within the radio range of the other master node, that are not currently members of a piconet.

Messages for MCS Procedures

An INQUIRY message intended for an MCS set-up may use a specific inquiry access code (IAC), such as a Dedicated IAC (DIAC). In this way nodes that are not willing to take part in an MCS can decide to do so during the INQUIRY phase. For instance, a node may only be interested in a certain service (printer, accesspoint etc.) or may not be capable of taking part in an MCS due to processing constraints, etc. Moreover, the use of a DIAC for MCS set-up (MCS-DIAC) may trigger a specific use of the FHS packet sent in response to the MCS-DIAC. For example, the MCS-DIAC may use the class of device field (24 bits) to carry information on scatternet topology to enhance the MCS forming. The 16-bit Non-significant Address Part (NAP) in the BD-ADDR could also carry other (additional) information since it is not used during the MCS establishment (the Lower Address Part is used for DAC generation and the Upper Address Part is used to generate the HEC). However, the entire BD_ADDR of the responding node would not be known by the inquiring node and if it must be known for routing reasons it needs to be conveyed in a packet after the connection is established.

The type of information carried in the fields described above may also vary depending on the state of the responding node, i.e., master, slave, idle, or combinations of master/slaves, which may be encoded in the unused bits of the FHS packet. A master node could respond with the scatternet identity in the NAP of its BD-ADDR field, but carry the normal node information in the class of device field. For more information on scatternet identities, the interested reader should refer to U.S. patent application Ser. No. 09/709,643 “Random Identity Management In Scatternets” by Johan Rune filed Nov. 13, 2000, the entire disclosure of which is herein expressly incorporated by reference. A slave node may have the scatternet identity in the NAP and carry the LAP of its master node in the class of device field. The LAP could be used by the inquiring node to generate the master's DAC to page that node directly to, for instance, join the piconet of that master. It would also be possible to let the NAP field carry both the scatternet identity and the master's UAP (Upper Address Part) in the NAP field. Since the UAP is 8 bits, this would leave 8 bits for the scatternet identity, which should be sufficient to identify a scatternet. This way both the LAP and the UAP of the slave node's master node would be conveyed to an inquiring node. A slave node node with more than one master node should respond with the LAP (and UAP) of the master with largest number of slaves, which will be less than 7 nodes. A node that is both master and slave will respond as a master. An idle node should send the information as originally defined for the class of device field and the BD_ADDR (NAP) field.

The knowledge of scatternet identity of the responding unit can be used to decide to limit the degree of connectivity in an MCS. As described earlier, the master nodes may know the BD_ADDR of the master nodes in the neighboring piconets, which then have the same scatternet identity. If an inquiring master node receives an FHS packet carrying the same scatternet identity as itself, a connection to the node is only made if the node is not in a neighboring piconet. This check is done by matching the LAP+UAP of the stored neighbor addresses and the LAP+UAP parts of the address in the FHS packet if it is a master node responding, or the LAP part of the address in the class of device field and, if available, the UAP part of the address in the NAP field of the FHS packet if the responding node is a slave node responding. If the responding node is a slave node the class of device field and the NAP field respectively contain the LAP and, possibly, the UAP of the slave node's master node's BD_ADDR according to the description above.

The exchange of management and control information between masters and slaves in one piconet, and master to master between piconets, should be part of an MCS protocol format common to all nodes. The MCS protocol entity should be a part of the Bluetooth Network Encapsulation Protocol (BNEP). A specific logical link connection (L2CAP) may be used to convey the MCS control and management traffic. However, when user traffic is sent over the MCS different L2CAP connections may be used. In some cases the MCS related functions may be mapped to LMP related functions and the information carried in LMP packets. The latter may introduce new link management functions and extensions of the LMP packet format.

In the master-to-master MCS communication case packets may need to pass through an intermediate MCS gateway (forwarding) node between the piconets. Thus the masters should be able to address each other directly. A straightforward way to do this is to use the node address format used in the BNEP (BD_ADDR or a shorter address format). Alternatively, a piconet local ID of the adjacent master nodes could be introduced and be stored in the gateway nodes. This would minimize the overhead per packet since the number of adjacent masters most likely is limited (an address of one or two bytes is sufficient). A packet from a master node to another master node, passing through a multiple slave gateway, is addressed locally, sent to the gateway node, forwarded to the right slave based on the local address and finally forwarded to the master.

Traffic Scatternet

As described above, the MCS is designed to enable an optimal information spreading among nodes in an overall scatternet. The MCS may be used to locate another node based on the node's address or name. Once this other node is found the MCS may also be used to transport the actual data between the nodes. However, since an MCS is designed to collect as many nodes in as few piconets as possible, the capacity per node in each piconet may be rather low. Accordingly, using an MCS to transport actual data will generally provide a low throughput or higher delay for point-to-point traffic. Therefore, a TS is designed to provide better performance than an MCS for a particular set of nodes in terms of throughput and/or delay. Due to the ability of Bluetooth to handle overlay piconets (using the aforementioned HOLD mode), instead of sharing the capacity in an MCS, more capacity could be gained if a new scatternet, such as a TS, is dedicated to carry only a selected traffic stream. So that the overall capacity of the MCS is not unnecessarily reduced, once the traffic stream between the two nodes has finished the TS may be torn down, preferably after a time out period.

In accordance with the present invention when an originating node needs to communicate with a destination node, and the originating node does not have a path set up with the destination node, the originating node will make a request to the network to find a path to the destination node. If Internet Protocol (IP) is implemented as the network protocol, and the underlying Bluetooth scatternet provides a broadcast-like media, the link layer (BD_ADDR) of the requested node should be mapped to the IP address. If, however, the link layer of the requested node is not mapped to the IP address, an address resolution for the IP address will be issued to the scatternet.

The MCS will then find the requested node by asking for a node with the IP address in question. However, a broadcast mechanism which integrates address resolution and path establishment can be implemented. For more information on how to integrate address resolution and path establishment, the interested reader should refer to U.S. patent application Ser. No. 09/455,460 “Broadcast As A Triggering Mechanism For Route Discovery In Ad-Hoc Networks” to Larsson et al. filed Dec. 6, 1999, the entire disclosure of which is herein expressly incorporated by reference. In addition, the IP addresses, and their mapping to BD_ADDRs of the nodes in the piconet may be stored in the piconet information database to limit the spread of the address resolution request, and hence, the address resolution request can be resolved by the master nodes of each piconet. The address resolution request can be further limited if the MCS gateways store the piconet information database of each piconet which is a member of the MCS. Further, instead of the requested IP address, a name, or even more generic, a service, could be searched for, i.e., a mapping of domain name server (DNS) and service lookup functionality may be performed with the MCS path finding. This mapping, however, requires more information to be stored in the piconet information database.

During the process of finding the requested node, a path will be set up through the MCS between the source node and the destination node. The TS establishment then can be considered a route update procedure to determine if there is a better path in the scatternet between the source node and the destination node.

General TS Establishment Procedures

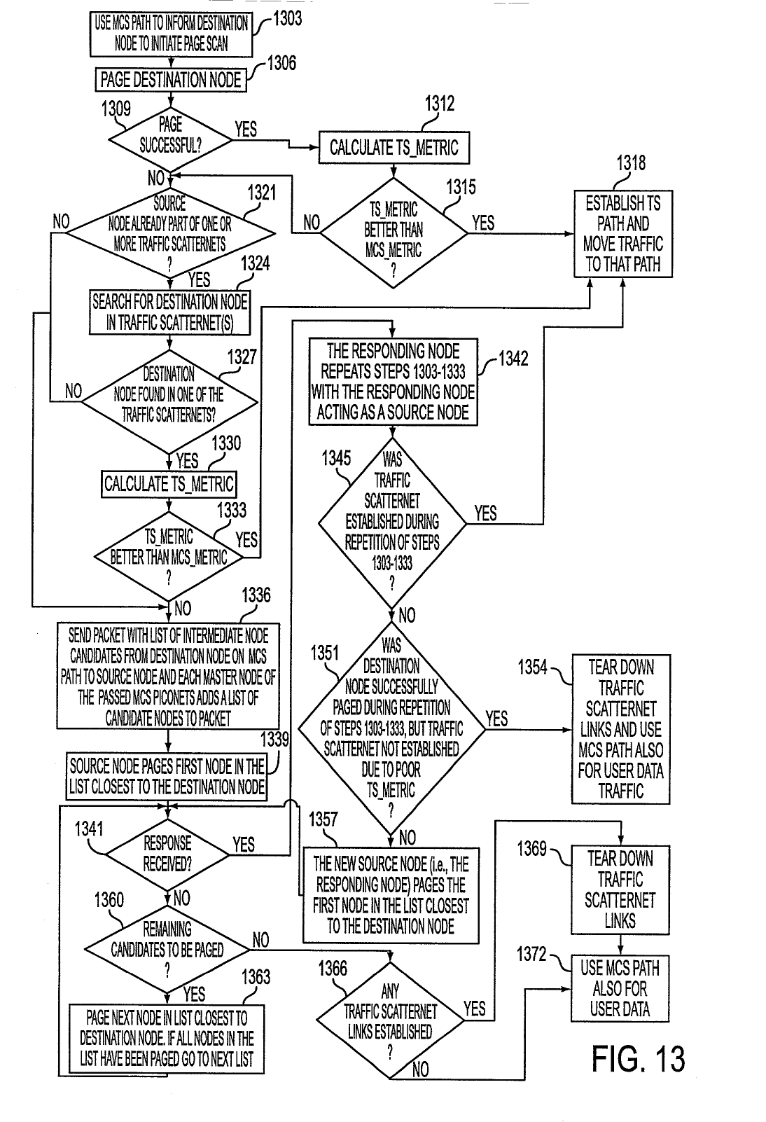

FIG. 13 illustrates an exemplary method for TS establishment in accordance with the present invention. As described above, prior to TS path establishment an MCS path between the source node and the destination node will be established. Accordingly, prior to TS path establishment a variable for the quality, e.g., number of hops or capacity, to the destination node in the MCS, also known as the MCS_METRIC, is established. Initially, the source node uses the MCS path to inform the destination node to initiate a PAGE scan, i.e., to scan for an anticipated paging message, (step 1303). A source node then pages the destination node (step 1306) and determines whether the page was successful i.e., the source node determines whether it has received a response to the page (step 1309). If the page was successful (“Yes” path out of decision step 1309) then the source node calculates a TS_METRIC, i.e., a measure of the quality of cost of the path between the source and destination node, for the path which the page message traversed across the MCS (step 1312). The source node then determines whether the TS_METRIC is better than the MCS_METRIC (step 1315). If the source node determines that the TS_METRIC is better than the MCS_METRIC (“Yes” path out of decision step 1315) then the source node establishes a TS path to the destination node and moves traffic to the established TS path (step 1318).

If the source node determines that the TS_METRIC is not better than the MCS_METRIC (“No” path out of decision step 1315) or if the page was not successful (“No” path out of decision step 1309) then the source node determines whether it is already a part of one or more traffic scatternets (step 1321). If the source node is already part of one or more traffic scatternets (“Yes” path out of decision step 1321) then the source node searches for the destination node in the traffic scatternets (step 1324) and determines whether the destination node is found in one or more of the traffic scatternets (step 1327). If the destination node is found in one of the traffic scatternets (“Yes” path out of decision step 1327) then the source node calculates the TS_METRIC between the source node and the destination node for the traffic scatternet (step 1330). The source node then determines whether the TS_METRIC is better than the MCS_METRIC (step 1333). If the TS_METRIC is better than the MCS_METRIC (“Yes” path out of decision step 1333) then the source node establishes the TS path and moves traffic to that path (step 1318).

If the source node is not already part of one or more traffic scatternets (“No” path out of decision step 1321), the destination node is not found in one of the traffic scatternets (“No” path out of decision step 1327) or the TS_METRIC is not better than the MCS_METRIC (“No” path out of decision step 1333) then the destination node sends a packet with a list of intermediate candidate nodes from the destination node on the MCS path to the source node, and each master node of the past MCS piconet adds a list of candidates to the packet (step 1336). The source node then pages the first node closest to the destination node in the list (step 1339) and determines whether it has received a response from the paged node (step 1341).

If the source node determines it has received a response from the paged node (“Yes” path out of decision step 1341) then the responding node, i.e., the paged node, repeats the procedure described in connection with steps 1303-1333, wherein the responding node acts as a source node (step 1342). It is then determined whether a traffic scatternet was established during the repetition of the procedure described in connection with steps 1303-1333 (step 1345). If a traffic scatternet was established (“Yes” path out of decision step 1345) then data can be moved over to the traffic scatternet and traffic scatternet establishment is ended (step 1318).

If a traffic scatternet was not established (“No” path out of decision step 1345) then it is determined whether the destination node was successfully paged during the repetition of the procedure described above in connection with steps 1303-1333, but that the traffic scatternet was not established due to a TS_METRIC which was less than the MCS_METRIC (step 1351). If the destination node was successfully paged but the traffic scatternet was not established due to a poor TS_METRIC (“Yes” path out of decision step 1351) then the traffic scatternet links are torn down and the MCS path is used for user data traffic (step 1354). If the destination node was not successfully paged (“No” path out of decision step 1351) then the “new source node”, i.e., “the responding node”, pages the first node in the list closest to the destination node (step 1357) and determines whether a response was received (step 1341). If it is determined that a response was received (“Yes” path out of decision step 1341) then the procedure described above in connection with steps 1342-1357 are repeated with the “new responding node” as the “responding node”.

If it is determined that no response is received (“No” path out of decision step 1341) then the source node determines whether there are any remaining candidate nodes to page (step 1360). If it is determined that there are remaining candidates to page (“Yes” path out of decision step 1360) then the next node in the list closest to the destination node is paged, and if all nodes in the list have been paged then the closest node to the destination node in the next list is paged (step 1363) and it is determined whether a response has been received (step 1341) and processing proceeds as described above. If it is determined that there are no remaining candidate nodes to page (“No” path out of decision step 1360) then it is determined whether any traffic scatternet links have been established (step 1366). If it is determined that traffic scatternet links have been established (“Yes” path out of decision step 1366) then the traffic scatternet links that have been established are torn down (step 1369). If traffic scatternet links have not been established (“No” path out of decision step 1366), or if the traffic scatternet links have been torn down (step 1369) then the MCS path is used to transport the user data traffic (step 1372).

To avoid having states for each traffic flow, TSs and MCSs should generally not be differed between in the routing tables stored in the various nodes. However, to manage a switch between an MCS and a TS and a node that is also part of the MCS path, the new TS entry should not be used until a TS_SWITCH packet is received by the TS entity. Otherwise, data packets would start to flow in parts of the TS before the decision has been made as to whether or not to use the TS path.

It will be recognized that the above described TS establishment procedures are not only applicable in the context of an MCS, but are equally applicable in a general Bluetooth scatternet scenario where no distinction is made between MCSs and TSs. For example, if two communicating nodes in a general Bluetooth scatternet scenario are connected to the same scatternet, the above described procedures can be used to establish a more efficient connection and to optimize communication between the two nodes.

TS Establishment Protocol

The exchange of information between the nodes in the TS should be part of a TS protocol format common to all nodes. The TS protocol entity should be a part of the BNEP. The connectivity provided by the MCS may be used to convey TS control information or a specific logical link connection (L2CAP) may be used to convey the TS control traffic. Further, other already existing TSs may be used to carry TS control traffic. However, when user traffic is sent over the TS, a separate L2CAP connection should be used. In some cases the TS related functions may be mapped to the LMP related functions and the information carried in the LMP packets. This may introduce new link management functions and extensions of the LMP packet format. During TS establishment packets may need to pass through an intermediate TS/MCS gateway node between the piconets. Thus the nodes should be able to address each other directly and as in the MCS scenario the node address format used in the BNEP, e.g., BD_ADDR or a shorter address format, may be used.

TS Establishment Alternatives

Establishing a traffic scatternet means establishing a number of interconnected piconets optimized for user communication between two nodes in an MCS. This involves selecting nodes in the MCS between which new direct links are established, thereby creating a path between the two communication peers. If the Bluetooth high speed mode is supported by two interconnected nodes in a TS, the two nodes may switch to the high speed mode in order to further improve the efficiency of the TS. An alternative to establishing new direct links is to use already established TSs for parts of the path. If two potential TS nodes are located in the same piconet in the MCS and both the two potential TS nodes and the master of the piconet (if the master is not one of the two potential TS nodes) support the Bluetooth high speed mode, the two potential TS nodes may realize their common TS link by switching to the high speed mode (still within the MCS piconet) without prior establishment of a dedicated TS piconet. In the further description of TS establishment alternatives, although not specifically mentioned in each case, it is assumed that TS nodes may switch to the Bluetooth high speed mode on a TS link, whenever this is supported and considered desirable by the involved nodes. Typically, the number of hops in the TS should be minimized, however, other properties may be considered when assessing the efficiency of a TS. A TS could be built in either direction between two communicating nodes. Henceforth, the node initiating this selection procedure is referred to as the start node and its communication peer is referred to as the end node.

Candidate Node Ratings

When selecting the node for a TS, certain candidate nodes are evaluated. Each candidate node is assigned a certain TS rating value depending upon its properties. The rating value should reflect how appropriate the node is for the potential TS. The combination of TS rating values of all the nodes of a TS form the TS_METRIC. The more appropriate the node, the higher the rating value. According to exemplary embodiments of the present invention the TS rating value of a candidate node is calculated based on five parameters: reachability, the number of TS hops resulting from a potential connection of the node, number of hops in the MCS from the start node, offered capacity and number of piconet memberships.

Reachability refers to a node's ability to reach either the start node, the end node, or any other of the candidate nodes. In this context “reach” means either through a potential new link or via an existing TS. If a TS is used for the relevant reachability, the assigned rating value will vary with the number of hops in the TS (or with some other measure of the efficiency of the utilized TS). Reachability via an efficient, e.g., single hop, TS may or may not result in a higher rating value than reachability through a potential new link. If the node cannot reach any other relevant nodes, through either an existing TS or via a new link, the node is disqualified as a candidate node and its total rating value will be 0.

With regard to the second property of the TS rating value, the number of TS hops resulting from a potential connection of the node, having few hops in the TS is highly valuable for the efficiency of the TS. Therefore, a node whose TS membership results in few TS hops is assigned a high TS rating value.

With regard to the third property of the TS value, the number of hops in the MCS from the start node, being far away from the start node is considered a valuable property when the TS is being established. Since the further a node is from the start node the closer the node is to the end node, and the fewer remaining TS hops exist, it is desirable for a node to be closer to the end node. If a node is the next hop node along a route to the end node, the node's TS rating value is somewhat increased since this status indicates that the node is probably located in the general direction of the end node.

Since different nodes have different capacity to offer a potential traffic scatternet, a node that offers more capacity is of course more valuable for a TS than a node that offers less. Hence, a node which offers greater capacity will have a greater TS rating value. The more piconets that a particular node is a member of the less throughput can be expected from the particular node. Accordingly, irrespective of the other properties, a node may be disqualified as a TS candidate node, if it already is a member of too many piconets. For example, the threshold could be 3 piconet memberships.

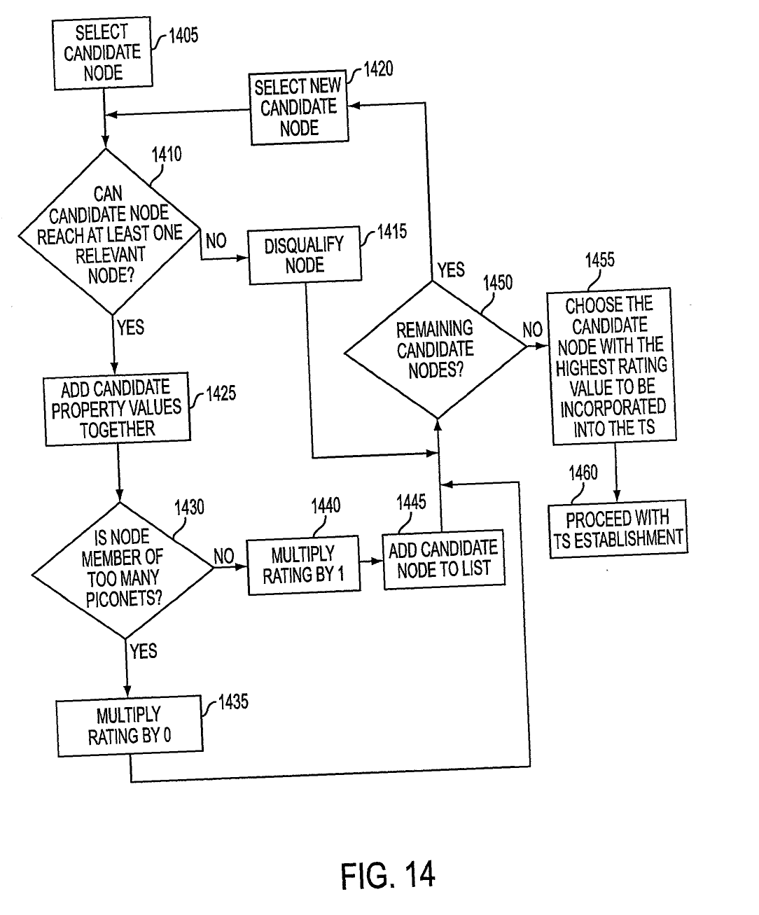

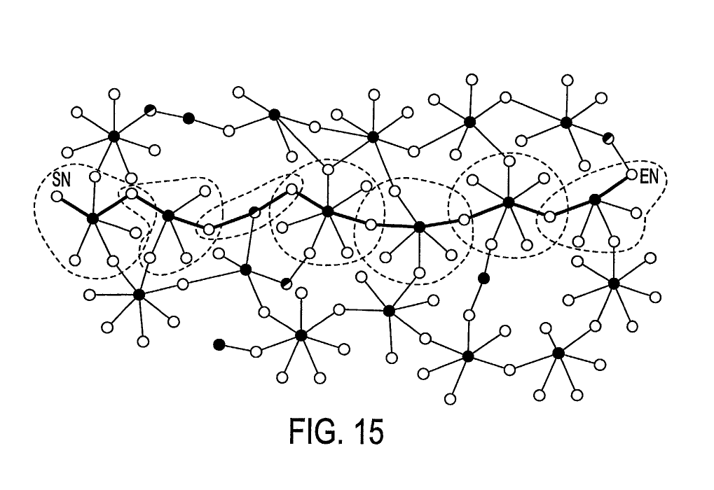

FIG. 14 illustrates an exemplary method for TS establishment in accordance with the present invention. The method described in connection with FIG. 14 uses the TS rating value of candidate nodes to determine whether or not to include the candidate node in the TS. Initially a candidate node, i.e., a node in the MCS path, is selected (step 1405). Next it is determined whether the candidate node can reach at least one relevant node (step 1410). Hereinafter, a relevant node is the end node, the start node or another candidate node which is already chosen to be incorporated in the TS. If the candidate node cannot reach at least one relevant node (“No” path out of decision step 1410) then the node is disqualified (step 1415). After a node is disqualified (step 1415) it is determined whether there are any remaining candidate nodes (step 1450). If there are no remaining candidate nodes (“No” path out of decision step 1450) then the candidate node with the highest rating value is chosen to be incorporated into the TS (step 1455) and TS establishment is begun (step 1460). If there are remaining candidate nodes (“Yes” path out of decision step 1450) then a new candidate node is selected (step 1420) and the process continues with the new candidate node.

If a candidate node can reach at least one relevant node (“Yes” path out of decision step 1410) then the candidate node's property values except for piconet membership, i.e., four of the five properties which make up the TS rating value, are added together (step 1425). After the candidate property values have been added together (step 1425) it is determined whether the candidate node is a member of too many piconets, e.g., more than three piconets (step 1430). If the node is a member of too many piconets (“Yes” path out of decision step 1430) the TS rating value for the candidate node is multiplied by 0 (step 1435). Next it is determined whether there are any remaining candidate nodes (step 1450) and processing proceeds as described above.

If, however, the node is not a member of too piconets (“No” path out of decision step 1430) then the TS rating value is multiplied by 1 (step 1440) and the candidate node is added to the candidate node list (step 1445). Next it is determined whether there are remaining candidate nodes to be evaluated (step 1450) and processing proceeds as described above.

Although the method described above in connection with FIG. 14 describes multiplying a candidate nodes TS rating value by 0 if it is a member of too many piconets, it will be recognized that instead a diminishing number, e.g., a fraction, can be multiplied by the TS rating value such that the more piconets that a node is a member of a lower total TS rating value would result.

The method described above in connection with FIG. 14 is performed by the master of each piconet, such that a master of the piconet creates a list of potential candidate nodes along with each candidate nodes TS rating value. If the list is non-empty the master then selects one or more candidate nodes to be incorporated in the TS. In one embodiment the master selects only one candidate node, the one with the highest TS rating value. In another embodiment the master may choose more than one candidate node (provided that there are more than one candidate nodes in the list), the candidate nodes with the highest TS rating values, to potentially be incorporated in the TS. In this case the final choice between these selected candidate nodes will be made by the end node.

According to exemplary embodiments of the present invention TS establishment proceeds according to two phases. In the first phase a number of TS candidate nodes, also referred to as potential TS nodes, in the MCS between a start node and the end node are identified. The identification of the TS candidate nodes in the MCS creates a logically linked chain of nodes, or a tree of nodes with several branches. Once potential candidate nodes are identified, the TS is established by paging between the identified nodes. One consideration for identifying suitable candidate nodes is whether or not reachability information, i.e., information about which other nodes a node can hear and potentially connect to, is available for each node. In the first case when reachability information is available the information will be available in the node itself and possibly also in the node's master node, i.e., in the piconet information database. Reachability information may not be available either because it simply does not exist or because the INQUIRY and INQUIRY SCAN substates are so infrequently entered by the nodes in the MCS that reachability information becomes too incomplete and unreliable.

FIG. 15 illustrates and exemplary MCS in which a TS is established. In FIG. 15 slave nodes are illustrated by white circles, master nodes are represented by dark circles, and nodes which act as both masters and slaves are illustrated by half dark half white circles. The dashed lines around particular piconets indicate piconets from which candidate nodes may be selected for establishment of a TS path between the start node (SN) and the end nodes (EN). The darkened links connecting various nodes between the start node and the end node represent the MCS route between the start node and the end node. When reachability information is available, a message is passed through the MCS route between the start node and the end node. In each piconet that the message passes through the master node of the particular piconet selects a number of candidate nodes, if any, and stores them in the message before it is forwarded to the next node in the MCS path. The message passed between the start node and the end node along the MCS route may be a dedicated BNEP message or, maybe a modified route reply message. In either case this message will be referred to as a TS candidate message.

So that TS establishment does not unnecessarily increase the load in the MCS, the TS candidate message is not broadcast throughout the MCS, but instead is sent along the MCS route between the start node and end node. If a dedicated BNEP message is used, it is sent along an existing MCS route. If, however, a modified route reply message is used, it is sent along the route that was reserved by the preceding route request message. The procedures involved with the transfer and handling of the TS candidate message will be herein referred to as TS candidate tree building phase or the TS candidate chain building phase. When the TS candidate message reaches the end node, the end node selects the branch, if there is more than one, in the tree of candidate nodes that will constitute the actual TS path. The end node will then send a message to the start node via each of the candidate nodes in the selected branch. This message, will be referred to herein as a confirmation and PAGE synchronization message, which confirms the final selection of the TS candidate nodes and conveys the PAGE scheduling information between the potential TS nodes. The procedures involved with the transfer and handling of the confirmation in PAGE synchronization message is called the confirmation and PAGE synchronization phase. After the confirmation in PAGE synchronization phase, the TS is actually established by PAGE procedures performed more or less in parallel between the potential TS nodes. These procedures will be here and referred to as the paging phase.

The particular method for the TS building phase will depend upon whether each piconet master selects a single candidate node or more than one candidate node. If each master selects only a single candidate node the method will be referred to as the TS candidate chain building phase, which is simpler to implement and causes less load in the MCS. When a master node selects more than one candidate node the method is referred to as the TS candidate tree building phase, which provides a more robust method for establishing the TS path because it provides alternative candidate nodes to be used if the paging step is unsuccessful. Furthermore, the TS candidate chain building phase has greater risk of failure since there is a risk that no node in a subsequent piconet between the start nodes and the end nodes can reach any of the preceding candidate nodes.

TS Chain Building: Start Node

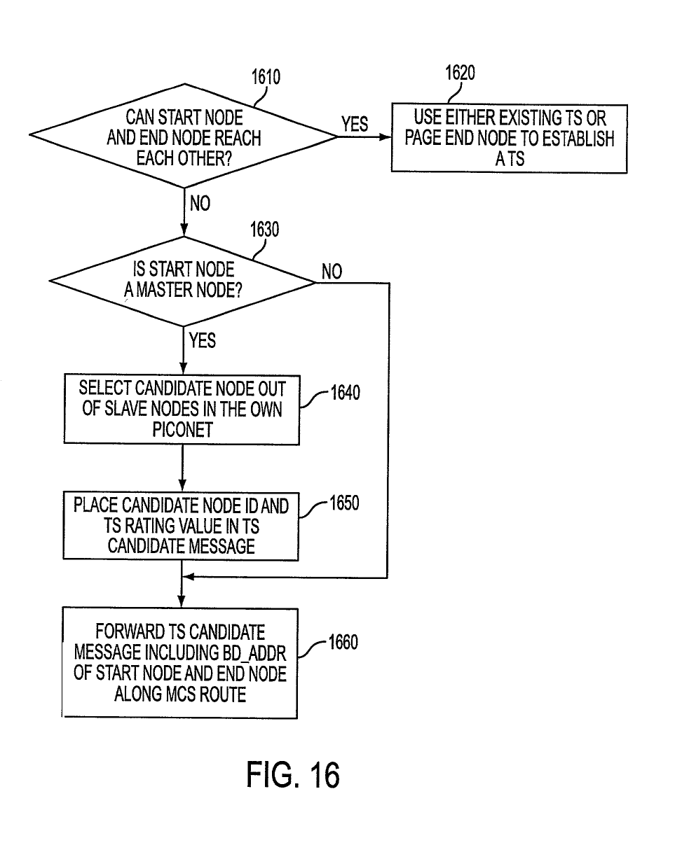

FIG. 16 illustrates an exemplary method for the TS candidate chain building phase in the start node in accordance with the present invention. Initially the start node determines whether it can reach the end node directly, either via a new link or via an existing TS (step 1610). If the start node and the end node can reach each other directly (“Yes” path out of decision step 1610) then the start node uses either the existing traffic scatternet to exchange information with the end node or the start node will page the end node to establish a traffic scatternet (step 1620). If the start node and the end node cannot reach other directly (“No” path out of decision step 1610) then the start node determines whether it is a master node (step 1630). If the start node is a master node (“Yes” path out of decision step 1630) then the start node selects the candidate node with the highest TS rating value out of the slaves in its piconet (step 1640) and places the candidate node ID and TS rating value in the TS candidate message (step 1650). If the start node is not a master node (“No” path out of decision step 1630) or after the start node has placed the candidate node ID in the TS candidate message (step 1650) the start node will forward the TS candidate message including the BD_ADDR of the start and end nodes along the MCS route (step 1660).

TS Chain Building: First Intermediate Node

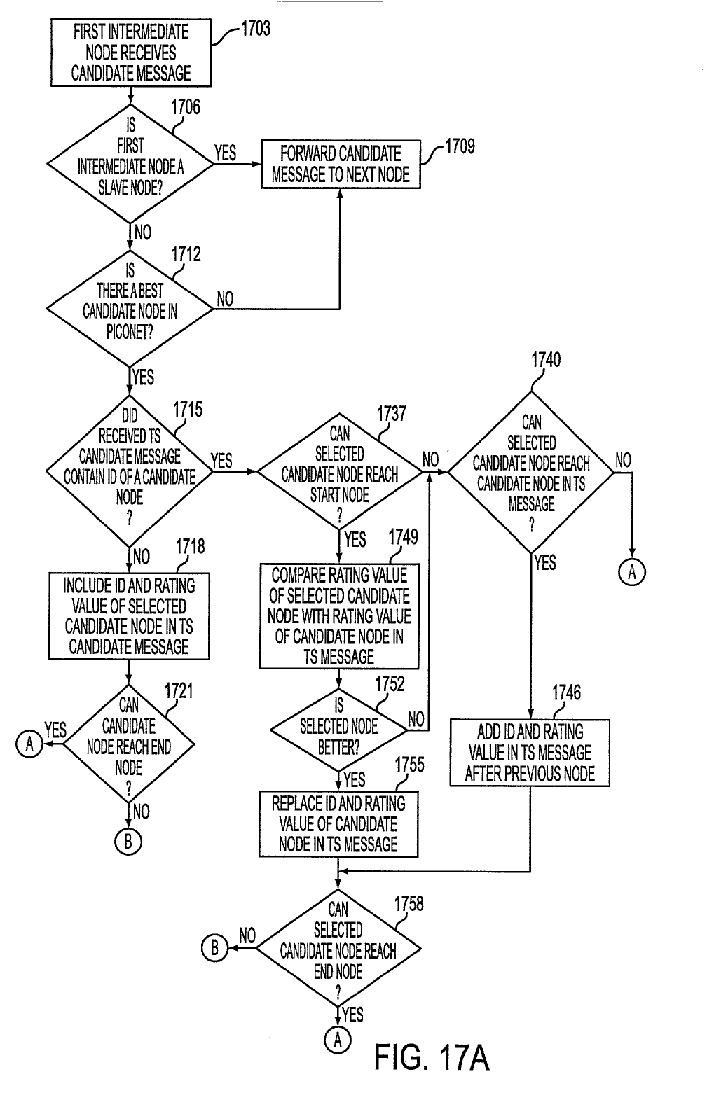

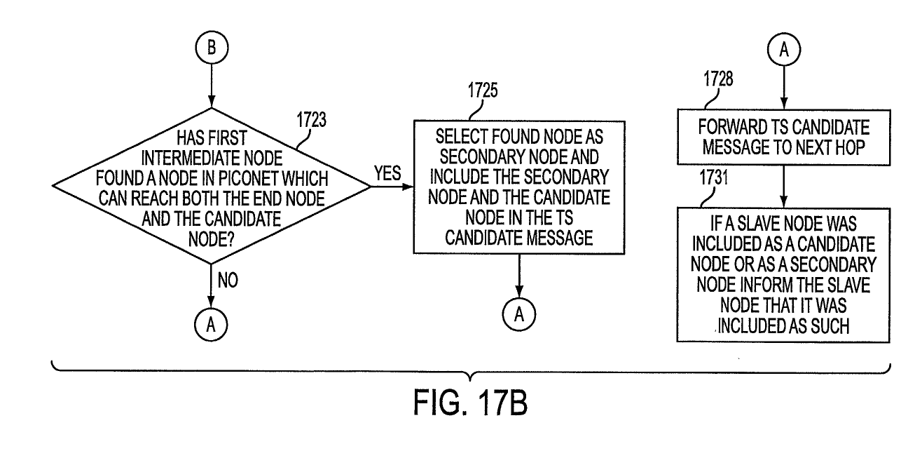

The first node in the MCS path between the start node and the end node is referred to as the first intermediate node. FIGS. 17A and 17B illustrate an exemplary method for the TS candidate chain building phase in the first intermediate node in accordance with the present invention. The first intermediate node receives the candidate message (step 1703) and determines whether it is a slave node (1706). If the first intermediate node is a slave node (“Yes” path out of decision step 1706) then the first intermediate node will forward the candidate message to the next node (1709). If the first intermediate node is not a slave node (“No” path out of decision step 1706) then the first intermediate node determines whether there is a best candidate node in its piconet (step 1712). If the first intermediate node does not have a best candidate node in its piconet (“No” path out of decision step 1712), e.g., because none of the nodes in the first intermediate nodes piconets can reach any of the start node, the end node, or the previous candidate node, then the first intermediate node will forward the candidate message to the next node in the MCS path (step 1709).

If there is a best candidate node in the first intermediate node's piconet (“Yes” path out of decision step 1712) then the first intermediate node will determine whether the received TS candidate message contains the ID of a candidate node (step 1715). If the received TS candidate message does not contain an ID of a candidate node (“No” path out of decision step 1715) then the first intermediate node will include the ID and rating value of the selected candidate node in the TS candidate message (step 1718). The first intermediate node will then determine whether the candidate node can reach the end node (step 1721). If the candidate node cannot reach the end node (“No” path out of decision step 1721) then the first intermediate node determines whether it has found a node in its piconet which can reach both the end node and the candidate node (step 1723). If the first intermediate node has found a node in the piconet which can reach both the end node and the candidate node (“Yes” path out of decision step 1723) then the first intermediate node selects this node as a secondary node and includes the secondary node together with the candidate node in the TS candidate message (step 1725).

After the first intermediate node has included the secondary node and the candidate node in the TS candidate message (step 1725), the first intermediate node has not found a node in the piconet which can reach both the end node and the candidate node (“No” path out of decision step 1723), or if the candidate node can reach the end node (“Yes” path out of decision step 1721) then the first intermediate node will forward the TS candidate message to the next hop in the MCS route (step 1728). If a slave node was included as a candidate node or as a secondary node, the first intermediate node will inform the slave node that it was included in the TS candidate message as a candidate node or as a secondary node (step 1731).

If the received TS candidate message contains the ID of a candidate node (“Yes” path out of decision step 1715) then it is determined whether the selected candidate node can reach the start node (step 1737). If the selected candidate node cannot reach the start node (“No” path out of decision step 1737) the first intermediate node determines whether the selected candidate node can reach any node in the TS candidate node message (step 1740). If the selected candidate node cannot reach any of the nodes in the TS candidate message (“No” path out of decision step 1740) then the first intermediate node will forward the TS candidate message to the next hop in the MCS path (step 1728) and informs any slave node whether it was included in the TS candidate message (step 1731).

If the selected candidate node can reach any of the nodes in the TS candidate message (“Yes” path out of decision step 1740) then the first intermediate node adds the ID and rating of the selected candidate node in the TS candidate message after the previous node in the TS candidate message (step 1746). Next the first intermediate node determines whether the selected candidate node can reach the end node (step 1758). If the selected candidate node cannot reach the end node (“No” path out of decision step 1758) then the first intermediate node determines whether it has found a node in its piconet which can reach both the end node and the candidate node (step 1723) and processing proceeds as described above.

If the candidate node can reach the end node (“Yes” path out of decision step 1758) then the first intermediate node will forward the TS candidate message to the next hop in the MCS route (step 1728). If a slave node was included as a candidate node or as a secondary node, the first intermediate node will inform the slave node that it was included in the TS candidate message as a candidate node or as a secondary node (step 1731).

If the first intermediate node determines that the selected candidate node can reach the start node (“Yes” path out of decision step 1737) then the first intermediate compares the rating value of the selected candidate node with the rating value of the candidate node in the TS candidate message (step 1749). Next it is determined whether the selected candidate node has a better rating value than the candidate node in the TS candidate message (step 1752). If the selected candidate node is not better than the candidate node in the TS candidate message (“No” path out of decision step 1752) then the first intermediate node determines whether the selected candidate node can reach any node in the TS candidate node message (step 1740) and processing proceeds as described above.

If the selected candidate node is better than the candidate node in the TS candidate message (“Yes” path out of decision step 1752) then the first intermediate node replaces the ID and rating value of the candidate node in the TS candidate message with the ID and rating value of the selected candidate node (step 1755). Next the first intermediate node determines whether the selected candidate node can reach the end node (step 1758) and processing proceeds as described above.

TS Chain Building: Subsequent Intermediate Nodes

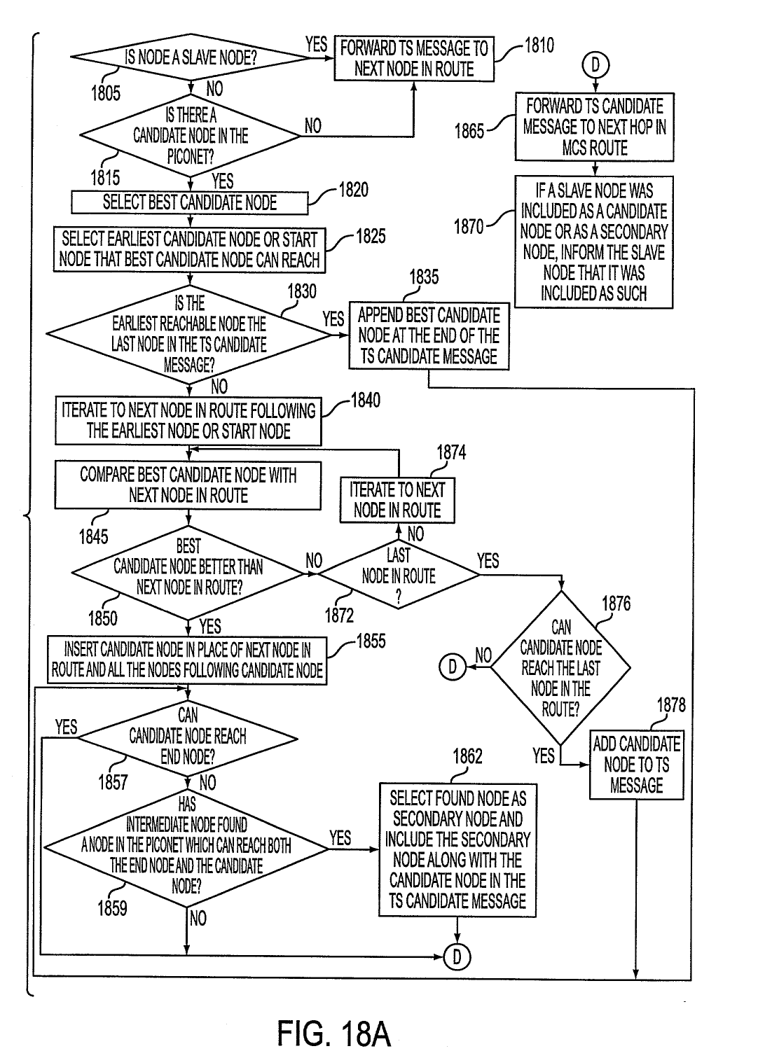

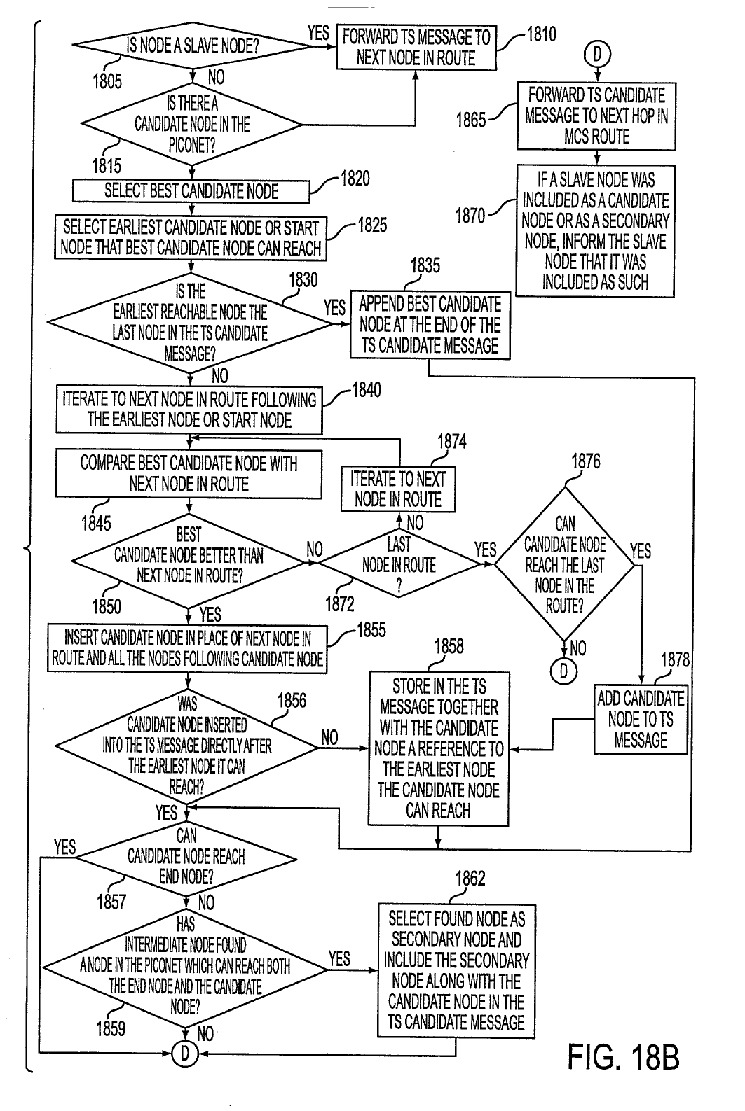

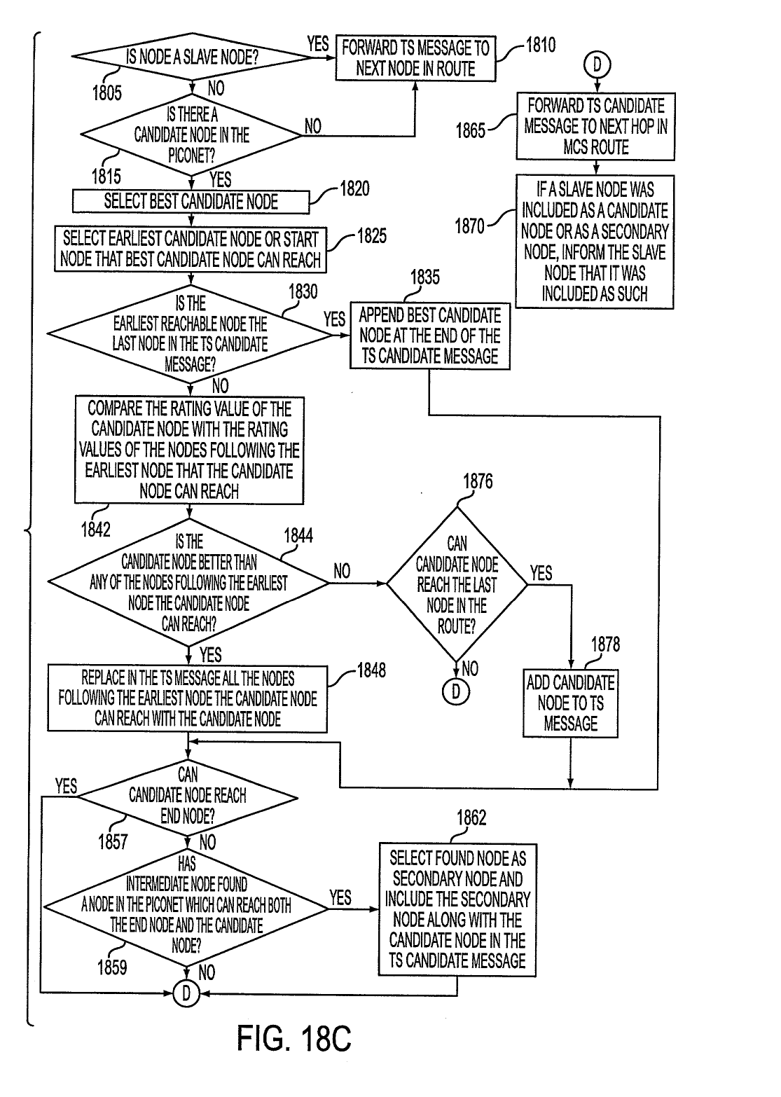

FIG. 18A illustrates an exemplary method for the TS chain building phase in a subsequent intermediate node which has received a TS candidate message including at least one candidate node, in accordance with one embodiment of the present invention. If a subsequent intermediate node receives a TS candidate message that does not include at least one candidate node, then the subsequent intermediate node will perform the procedures of the first intermediate node described above in connection with FIGS. 17A and 17B.

The subsequent intermediate node initially determines whether it is a slave node (step 1805). If the subsequent intermediate node is a slave node (“Yes” path out of decision step 1805) then the subsequent intermediate node forwards the TS candidate message to the next node in the MCS route (step 1810). If, however, the subsequent intermediate node is not a slave node (“No” path out of decision step 1805), i.e., that the subsequent intermediate node is a master node, then the subsequent intermediate node determines whether there is a candidate node in its piconet (step 1815). If the subsequent intermediate node determines that there is not a candidate node in its piconet (“No” path out of decision step 1815) then the subsequent intermediate node will forward the TS candidate message to the next node in the MCS route (step 1810).

If the subsequent intermediate node determines that there is a candidate node in its piconet (“Yes” path out of decision step 1815) then the subsequent intermediate node will select the best candidate node, of the candidate nodes in the piconet, based upon its TS rating value (step 1820). The subsequent intermediate node then selects the earliest candidate node or the start node from the TS candidate message that the selected best candidate node can reach (step 1825) and determines whether the earliest reachable node is the last node in the TS candidate message (step 1830). If the earliest reachable node is the last node in the TS candidate message (“Yes” path out of decision step 1830) then the subsequent intermediate node will append the selected best candidate node at the end of the TS candidate message and forward the TS candidate message to the next node in the MCS route (step 1835). Next the subsequent intermediate node determines whether the candidate node can reach the end node (step 1857). If the candidate node cannot reach the end node (“No” path out of decision step 1857) then it is determined whether the subsequent intermediate node has found a node in the piconet which can reach both the end node and the candidate node (step 1859). If the subsequent intermediate node has found a node in the piconet which can reach both the end node and the candidate node (“Yes” path out of decision step 1859) then the node which can reach both the end node and the candidate node is selected as a secondary node and is included in the TS candidate message along with the candidate node (step 1862).

If the candidate node can reach the end node (“Yes” path out of decision step 1857), the subsequent intermediate node has not found a node in the piconet which can reach both the end node and the candidate node (“No” path out of decision step 1859), or after a secondary node has been included in the TS candidate message (step 1862), the subsequent intermediate node forwards the TS candidate message to the next hop in the MCS route (step 1865). If a slave node was included as a candidate node or as a secondary node in the TS candidate message, then the subsequent intermediate node informs the slave node of such (step 1870).

If the earliest reachable node is not the last node in the TS candidate message (“No” path out of decision step 1830) then the subsequent intermediate node will iterate to the next node in the route stored in the TS candidate message following the earliest node or the start node (step 1840). The subsequent intermediate node will then compare the selected best candidate node with the next node in the route (step 1845) and will determine whether the selected best candidate node is better than the next node in the route based on the TS candidate values for each node (step 1850). If the selected candidate node is better than the next node in the route (“Yes” path out of decision step 1850) then the subsequent intermediate node determines whether the candidate node can reach the end node (step 1857) and processing proceeds as described above.

If the selected best candidate node is not better than the next candidate node in the route stored in the TS candidate message (“No” path out of decision step 1850) then the subsequent intermediate node determines whether the next node in the route is the last node in the route (step 1872). If the next node in the route is not the last node in the route (“No” path out of decision step 1872) then the subsequent intermediate node iterates to the next node in the route after the next node in the route determined in step 1840 (step 1874) and compares the best candidate node with the next node in the route (step 1845) and processing proceeds as described above.

If the next node in the route is the last node in the route (“Yes” path out of decision step 1872) then the subsequent intermediate node determines whether the candidate node can reach the last node in the route (step 1876). If the candidate node can reach the last node in the route (“Yes” path out of decision step 1876) then the subsequent intermediate node adds the candidate node to the TS candidate message (step 1878), determines whether the candidate node can reach the end node (step 1857) and processing proceeds as described above. If, however, the candidate node cannot reach the last node in the route (“No” path out of decision step 1876) the subsequent intermediate node forwards the TS candidate message to the next hop in the MCS route (step 1865). If a slave node was included as a candidate node or as a secondary node in the TS candidate message, then the subsequent intermediate node informs the slave node of such (step 1870).

The TS candidate message will continue to be forwarded from each subsequent intermediate node to the next subsequent intermediate node where each subsequent intermediate node will perform the procedures described above in connection with either FIG. 18A, if the TS candidate message includes at least one candidate node, or the procedures described above in connection with FIGS. 17A and 17B, if the TS candidate message does not contain at least one candidate node, until the TS candidate message reaches the end node.

FIG. 18B illustrates another exemplary method for the TS chain building phase in a subsequent intermediate node which has received a TS candidate message including at least one candidate node, in accordance with another embodiment of the present invention. The method of FIG. 18B is similar to the method described above in connection with FIG. 18A, and hence, like reference numerals in FIGS. 18A and 18B describe similar processes. Accordingly, for ease of understanding, only the differences between FIGS. 18A and 18B will be described below in connection with FIG. 18B. The differences between FIGS. 18A and 18B is the outputs of steps 1855 and 1878. After the candidate node is inserted in place of the next node in the route and all the nodes following the candidate message (step 1855), it is determined whether the candidate node is inserted into the TS candidate message directly after the earliest node it can reach (step 1856). If the candidate node was inserted into the TS candidate message directly after the earliest node it can reach (“Yes” path out of decision step 1856) then it is determined whether the candidate node can reach the end node (step 1857) and the processing proceeds in a manner similar to that described above in connection with FIG. 18A. If, however, the candidate node was not inserted into the TS candidate message directly after the earliest node it can reach (“No” path out of decision step 1856) then a reference to the earliest node the candidate node can reach is stored in the TS candidate message together with the candidate node (step 1858). After storing the reference to the earliest node in the TS candidate message then it is determined whether the candidate node can reach the end node (step 1857) and the processing proceeds in a manner similar to that described above in connection with FIG. 18A.

Returning now to the second difference between FIGS. 18A and 18B, after the candidate node is added to the TS candidate message (step 1878) then a reference to the earliest node the candidate node can reach is stored in the TS candidate message together with the candidate node (step 1858). After storing the reference to the earliest node in the TS candidate message then it is determined whether the candidate node can reach the end node (step 1857) and the processing proceeds in a manner similar to that described above in connection with FIG. 18A.

The reference (if included) is a potential “short-circuit” between the inserted candidate node and the earliest node the candidate node can reach. If, when the TS candidate message reaches the end node, the inserted candidate node and its reference are still included in the TS candidate message, then all the nodes between the inserted candidate node and the node it refers to are redundant and are removed from the TS candidate chain.

FIG. 18C illustrates yet another exemplary method for the TS chain building phase in a subsequent intermediate node which has received a TS candidate message including at least one candidate node, in accordance with yet another embodiment of the present invention. The method of FIG. 18C is similar to the method described above in connection with FIG. 18A, and hence, like reference numerals in FIGS. 18A and 18C describe similar processes. Accordingly, for ease of understanding, only the differences between FIGS. 18A and 18C will be described below in connection with FIG. 18C. The differences between FIGS. 18A and 18C is that steps 1840-1855 and steps 1872 and 1874 are replaced by steps 1842, 1844 and 1848. Accordingly, if the earliest reachable node is not the last node in the TS candidate message (“No” path out of decision step 1830) then the rating value of the candidate node is compared with the rating values of the nodes following the earliest node the candidate node can reach (step 1842). Next it is determined, based upon the nodes' rating value, whether the candidate node is better than any of the node following the earliest node the candidate node can reach (step 1844). If the candidate node is not better than any of the nodes following the earliest node the candidate node can reach (“No” path out of decision step 1844) then it is determined whether the candidate node can reach the last node in the route (step 1876) and the processing proceeds in a manner similar to that described above in connection with FIG. 18A.

If the candidate node is better than any of the nodes following the earliest node the candidate node can reach (“Yes” path out of decision step 1844) then the candidate node replaces all of the nodes following the earliest node the candidate node can reach in the TS candidate message (step 1848). Next it is determined whether the candidate node can reach the end node (step 1857) and processing proceeds in a manner similar to that described above in connection with FIG. 18A.

The differences between FIGS. 18A, 18B and 18C are due to the situation in which the new candidate node can reach the start node or any of the candidate nodes preceding the last candidate node included in the message, but the new candidate node is not better than the candidate node following the earliest candidate node that the new candidate node can reach. FIG. 18A illustrates a first alternative in which the new candidate node replaces the earliest candidate node that it is better than and all nodes following this candidate node.

If the new candidate node is better than any of the candidate nodes following the earliest candidate node it can reach, it would be beneficial to allow the new candidate node to replace the candidate node following the earliest candidate node the new candidate node can reach and all of the candidate nodes following the earliest candidate node. Accordingly, FIG. 18C illustrates an alternative in which the new candidate node replaces the node following the earliest candidate node it can reach and all the candidate nodes following. However, this replacement eliminates the possibility that a later candidate node, which can reach one of the candidate nodes following the earliest candidate node that the new candidate node can reach and which may be better than the new candidate node, is linked into the chain. Accordingly, FIG. 18B illustrates an embodiment in which the new candidate node replaces only the earliest candidate node that it is better than and all node following the earliest candidate node. In addition to the rating value, a reference to the earliest candidate node the new candidate node can reach is included in the TS candidate message along with the ID of the new candidate node. This reference can be as simple as a number representing the position of the earliest candidate node. Accordingly, when the TS candidate message reaches the end node, the end node can tell from the included reference that all the candidate nodes between the earliest candidate node that the new candidate node can reach and the new candidate node are redundant and can be cut out of the chain. This allows the new candidate node to be link into its most favorable position in the chain, while allowing the possibility to have a later candidate node link to the candidate node following the earliest candidate node the new candidate node can reach as the TS candidate node is forwarded along the MCS route.

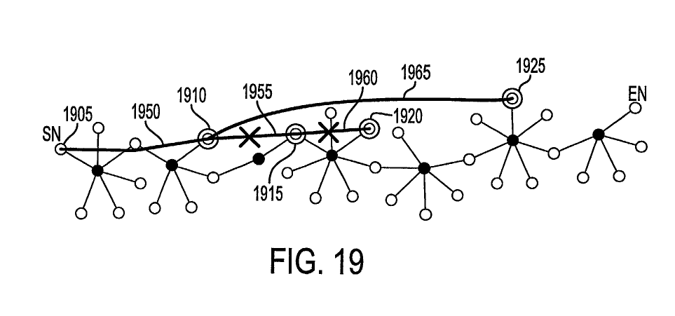

FIG. 19 illustrates the chain building phase in an exemplary MCS scatternet in accordance with the present invention. In FIG. 19 slave nodes are illustrated as white circles, master nodes are illustrated as darkened circles, slave candidate nodes are illustrated as white circles with an extra dark circle surrounding the white circle, and master candidate nodes are illustrated as dark circles with an extra circle surrounding the dark circle. As illustrated in FIG. 19 the start node (SN) 1905 has a logical link 1950 to candidate node 1910; candidate node 1910 has a logical link to candidate node 1915; and candidate node 1915 has a logical link to 1960 to candidate 1920. During the chain building phase illustrated in FIG. 19 it is determined that candidate node 1910 can reach candidate node 1925 via logical link 1965. Since it is desirable to have less nodes in a TS path, it is determined that logical link 1965 which connects candidate nodes 1910 and 1925 should be used in place of logical links 1955 and 1960. Accordingly, logical links 1955 and 1960 are “short circuited” as illustrated by the darkened X's over the logical links.

TS Chain Building: End Nodes

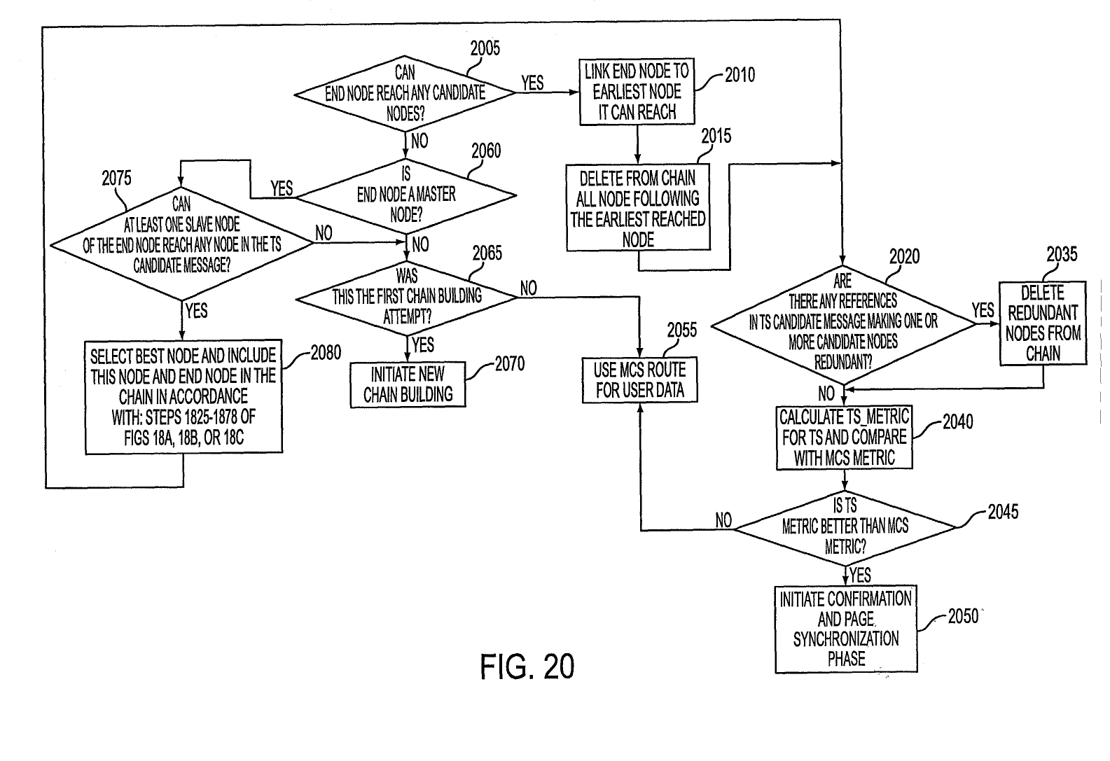

FIG. 20 illustrates an exemplary method for TS chain building in the end node in accordance with the present invention. When the TS candidate message has reached the end node, the end node determines whether it can reach any of the candidate nodes in the TS candidate message (step 2005). It will be recognized that since the TS candidate message is provided to the end node over the MCS route, the end node may receive a TS candidate message even though the end node cannot reach any of the candidate nodes. If the end node can reach one of the candidate nodes (“Yes” path out of decision step 2005) then the end node links to the earliest node it can reach in the path stored in the TS candidate message (step 2010) and deletes from the chain stored in the TS candidate message, i.e., the path stored in the TS candidate message, all nodes following the earliest node that the end node can reach (step 2015). The end node then determines if there are any references in the TS candidate message making one or more candidate nodes redundant (step 2020) in accordance with one of the alternative embodiments described for the subsequent intermediate nodes (i.e., the one illustrated in FIG. 18B).

If the end node determines that there are references in the TS candidate message making one or more candidate nodes redundant (“Yes” path out of decision step 2020) then the end node deletes the redundant nodes from the TS candidate chain (step 2035). After the end node has deleted redundant nodes from the TS candidate chain (step 2035) or if the end node has determined that there are no references in the TS candidate message making one or more of the candidate nodes redundant (“No” path out of decision step 2020) then the end node calculates the TS_METRIC for the TS and compares it with the MCS_METRIC (step 2040). Based on the comparison the end node determines whether the TS_METRIC is better than the MCS_METRIC (step 2045). If the end node determines that the TS_METRIC is better than the MCS_METRIC (“Yes” path out of decision step 2045) then the end node will initiate confirmation and page synchronization phase (step 2050). If, however, the TS_METRIC is not better than the MCS_METRIC (“No” path out of decision step 2045) then the end node will use the MCS route for the user data (step 2055).

If the end node determines that it cannot reach any of the nodes in the TS candidate message (“No” path out of decision step 2005) then the end node determines whether it is a master node (step 2060). If the end node is not a master node (“No” path out of decision step 2060) then the end node determines whether this was the first chain building attempt (step 2065). If the end node determines that this was not the first chain building attempt (“No” path out of decision step 2065) then the end node will use the MCS route for the user data (step 2055). If, however, the end node determines that this was the first chain building attempt (“Yes” path out of decision step 2065) then the end node will initiate a new chain building wherein the end node now becomes the start node and the start node becomes the end node in the chain building (step 2070). If the end node is a master node (“Yes” path out of decision step 2060) then the end node determines whether at least one slave node of the end node can reach any of the nodes in the TS candidate message (step 2075).

If one of the slave nodes of the end node can reach any of the nodes in the TS candidate message (“Yes” path out of decision step 2075) then the end node selects the best node, based upon on its TS rating value, and includes the selected best node and the end node in the chain in accordance with steps 1825-1878 of the method described above in connection with FIGS. 18A, 18B or 18C. Once the end node has performed steps 1825-1878 of the method described above in connection with FIGS. 18A, 18B or 18C then the end node will determine whether there are any references in the TS candidate message making one or more of the candidate nodes redundant (step 2020) and proceeds to determine whether to use the MCS route or the TS route (steps 2035-2055). If none of the slave nodes of the end node can reach any of the nodes in the TS candidate message (“No” path out of decision step 2075) then the end node proceeds to determine whether this was the first chain building attempt (step 2065) and then either uses the MCS path (step 2055) or initiates a new chain building (step 2070).

TS Chain Building: End Node Confirmation and Page Synchronization Phase

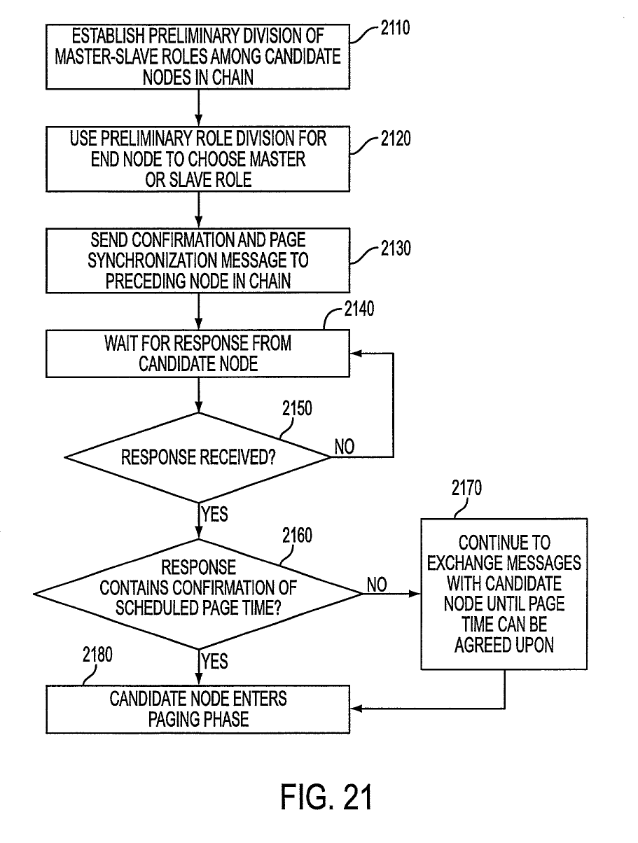

Once the end node has determined that the TS_METRIC is better than the MCS_METRIC, and hence has decided to use the TS path to exchange user data, the end node then begins the confirmation and PAGE synchronization phase. FIG. 21 illustrates an exemplary method in the end node for the confirmation and page synchronization phase in accordance with the present invention. Initially, the end node establishes a preliminary division of master-slave roles among candidate nodes in the chain (step 2110). To establish this preliminary division of master and slave roles among the candidate nodes in the chain, the end node may try to minimize the number of piconets in the TS. In such a case every second node in the chain should be a master node and every other node should be a slave node (and no node should assume dual roles in the TS). Based upon the preliminary role division the end node chooses to be either a master or slave node (step 2120) and sends a confirmation and page synchronization message to the preceding node in the TS candidate chain (step 2130). The end node then waits for a response from the candidate node which precedes the end node in the chain (step 2140) and determines whether it has received a response (step 2150).

If the end node has determined that it has not received a response (“No” path out of decision step 2150) then the end node continues to wait for a response from the candidate node until one is received (step 2140). If, however, the end node determines that a response has been received (“Yes” path out of decision step 2150) then the end node determines whether the response contains a confirmation of the scheduled page time (step 2160). If the end node determines that the response does not contain a confirmation of the scheduled page time (“No” path of decision step 2160) then the end node continues to exchange messages with the preceding candidate node until a page time can be agreed upon between the two nodes (step 2170). Once a page time has been agreed upon (step 2170) or if the response contains a confirmation of the scheduled page time (“Yes” path out of decision step 2160) then the preceding candidate node enters the paging phase (step 2180).

TS Chain Building: Intermediate Node Confirmation and Page Synchronization Phase

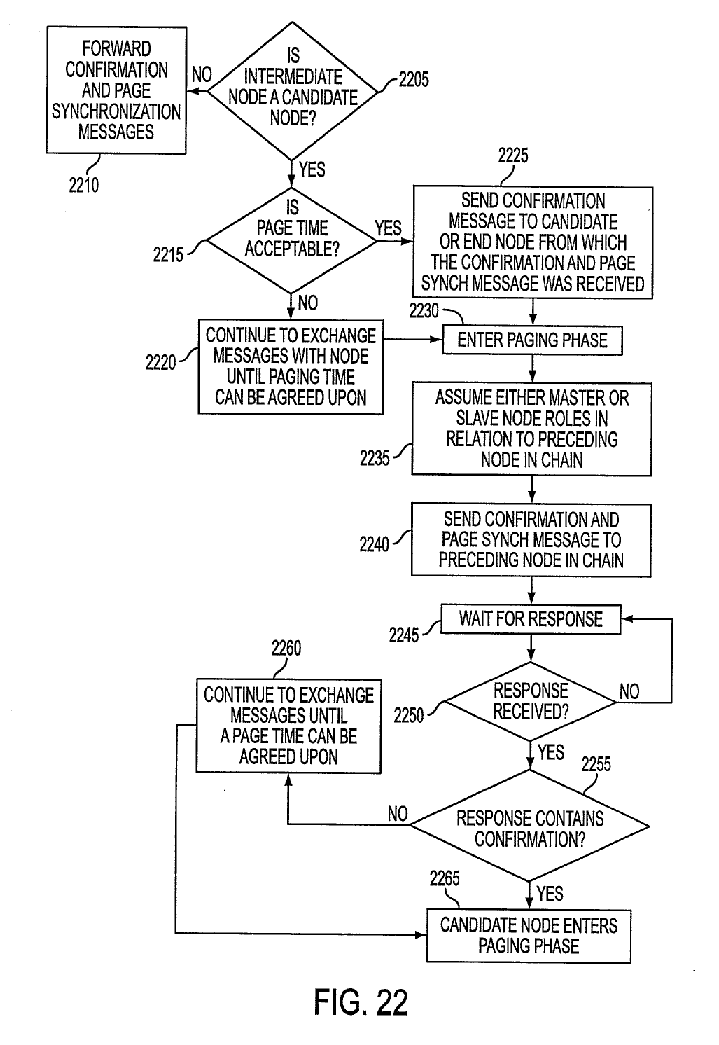

FIG. 22 illustrates an exemplary method in any intermediate node between the start node and the end node during the confirmation and page synchronization phase in accordance with the present invention. Initially, the intermediate node which has received the confirmation and PAGE synchronization message determines whether it is a candidate node of the TS based upon the contents of the synchronization and page message (step 2205). If the intermediate node is not a candidate node of the TS (“No” path out of decision step 2205) then the intermediate node will forward the confirmation and page synchronization messages to the next intermediate node (step 2210). If, however, the intermediate node is a candidate node (“Yes” path out of decision step 2205) then the intermediate node determines whether the page time is acceptable, i.e., whether the intermediate node has a previous “engagement” during the page time (step 2215). If the intermediate node determines that the page time is not acceptable (“No” path out of decision step 2215) then the intermediate node continues to exchange message with the previous intermediate candidate node or end node until a paging time can be agreed upon (step 2220). If the intermediate node determines that the page time is acceptable (“Yes” path out of decision step 2215) then the intermediate node sends a confirmation message to the previous candidate node or the end node from which the confirmation and page synchronization message was received (step 2225).

Once the confirmation message has been sent to the preceding candidate node or end node (step 2225), or after a paging time has been agreed upon (step 2220) then the intermediate node enters the paging phase (step 2230). The intermediate node then assumes either the master or slave node role in relation to the preceding node in the chain (step 2235), i.e., preferably such that the nodes in the TS path alternate between master nodes and slave nodes, and the intermediate node sends a confirmation and page synchronization message to the preceding node in the chain (step 2240). The intermediate node then waits for a response (step 2245) and determines whether a response has been received (step 2250). If a response has not been received (“No” path out of decision step 2250) then the intermediate node continues to wait for a response (step 2245). If the intermediate node determines that a response has been received (“Yes” path out of decision step 2250) then the intermediate node determines whether the response contains a confirmation (step 2255). If the response does not contain a confirmation (“No” path out of decision step 2255) then the intermediate node continues to exchange messages with the previous node or end node until a page time can be agreed upon (step 2260). Once a page time is agreed upon (step 2260) or if the response contains a confirmation of the page time (“Yes” path out of decision step 2255) then the candidate node enters the paging phase (step 2265).

TS Chain Building: Start Node Confirmation and Page Synchronization Phase

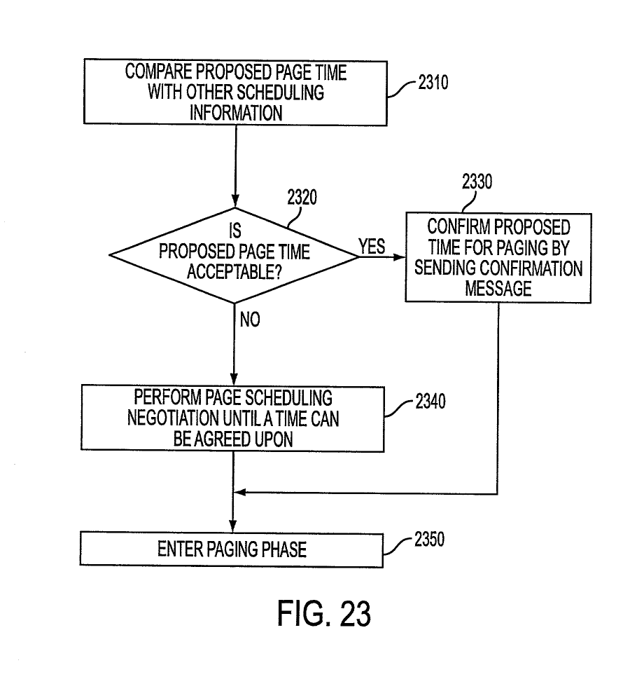

FIG. 23 illustrates an exemplary method for the confirmation and PAGE synchronization phase in a start node in accordance with the present invention. When a start node receives a confirmation and page synchronization message from a candidate node, the start node compares the proposed page time in the message with other scheduling information for the start node (step 2310) and determines whether the proposed page time is acceptable based upon the start nodes schedule (step 2320). If the start node determines that the proposed page time is acceptable (“Yes” path out of decision step 2320) then the start node confirms the proposed page time by sending a confirmation message to the preceding candidate node (step 2330). If, however, the start node determines that the proposed page time is not acceptable (“No” path out of decision step 2320) then the start node performs page scheduling negotiation with the preceding candidate node until a time can be agreed upon between the two nodes (step 2340). Once a page time has been agreed upon (step 2340) or after the start node sends the confirmation message (step 2330) then the start node enters the paging phase (step 2350).

TS Chain Building: Paging Phase

Once the confirmation and page synchronization phase has completed the nodes of the TS enter the paging phase. FIG. 24 illustrates an exemplary method in the start node, end node or any candidate nodes in the chain, during the paging phase in accordance with the present invention. Initially the node enters the page and/or page scan mode according to the agreed upon page scheduling and connects to the preceding and/or subsequent node in the TS chain (step 2405). The node then verifies that the TS is completely and successfully established (step 2410). This can be verified either explicitly using a chain verification message sent from the start node and end node along the chain, or implicitly by the absence of an error message from nodes where the paging has failed. The node then determines whether the TS establishment has been verified (step 2415). If the node determines that the establishment has been verified (“Yes” path out of decision step 2415) then the node can send data over the TS route (step 2420).

If the node determines that the TS establishment has not been verified (“No” path out of decision step 2415) then the node will initiate the chain repair procedure (step 2425). The chain could be repaired in several different ways, for example, the start node and the end node could both send a certain message along the chain (in opposite directions). The messages are sent via the established TS links, where possible, and otherwise using the MCS links. The message is collecting information about which TS links were successfully established and which were not. Accordingly, all nodes in the chain would obtain a complete picture of the gaps in the chain and a node at the edge of each gap could then initiate a local chain building to bridge the gap. The message which collects the information about successfully and unsuccessfully established TS links could possibly be the chain verification messages described above. In such a case the local chain building could start immediately after reception of the verification messages. Another way to repair the chain, would be simply to restart the chain building from scratch by either the start node or the end node.

After the chain repair procedure has been completed it is determined whether the repair procedure has changed the structure of the original chain (step 2430). If the repair procedure has not changed the structure of the original chain (“No” path out of decision step 2430) then it is verified whether the repaired TS is completely and successfully established (step 2410) and processing proceeds as described above. If the repair procedure has changed the original chain (“Yes” path out of decision step 2430) then the TS_METRIC of a new chain is determined and compared with the MCS_METRIC (step 2435) and it is determined whether the new TS_METRIC is better than the MCS_METRIC (step 2440). If it is determined that the new TS_METRIC is not better than the MCS_METRIC (“No” path out of decision step 2440) then the MCS route is used to transfer user data and the TS is torn down (step 2445). If, however, the new TS_METRIC is better than the MCS_METRIC (“Yes” path out of decision step 2440) then it is verified whether the TS is completely and successfully established (step 2410) and processing proceeds as described above.

TS Establishment: Tree Building

The TS path establishment procedures described above were performed wherein each master node includes only a single candidate node in the TS candidate message. However, it will be recognized, as described above, that a more robust method for TS path establishment can be accomplished when each master node includes several candidate nodes in the TS candidate message. The use of several candidate nodes for TS path establishment results in a tree of candidate nodes, whereas the use of a single candidate node in TS path establishment results in a singular chain being built. In the description of this embodiment each master node in the MCS route (including the start node if the start node is a master node) selects up to two candidates nodes out of the slaves in its piconet. However, it should be understood that the upper limit of two is only an example. The same principles could be used also for three of more candidate nodes per piconet in the MCS route.

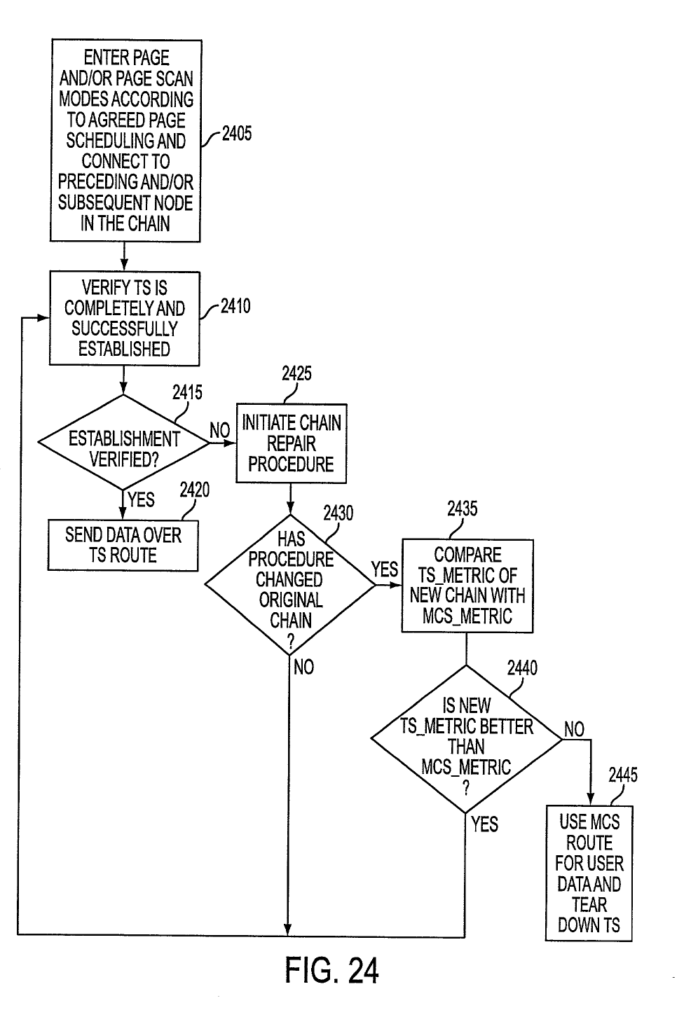

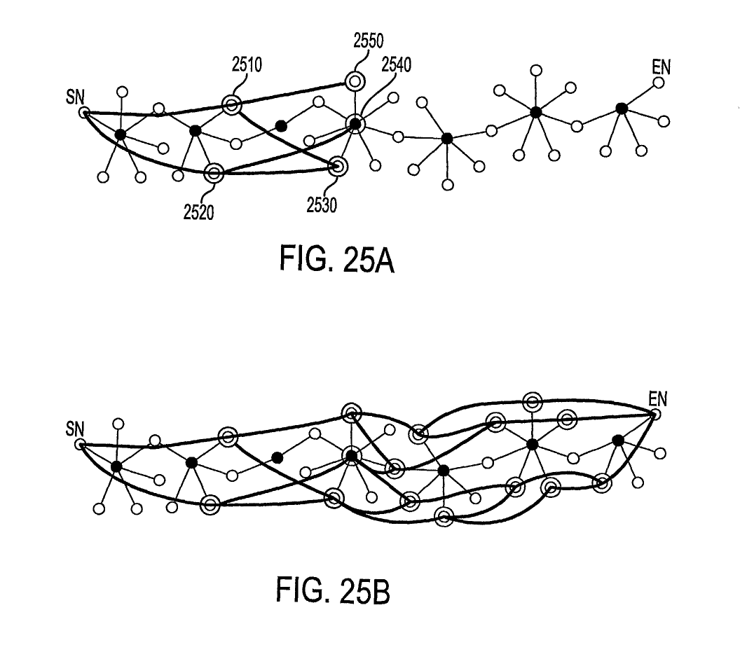

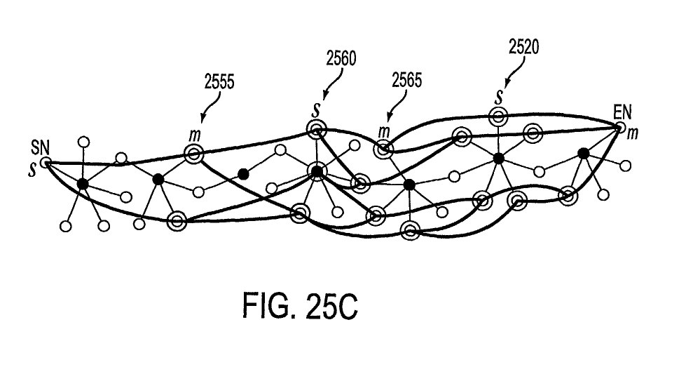

FIGS. 25A-25C illustrate trees of candidate nodes in accordance with exemplary embodiments of the present invention. In FIGS. 25A-25C slave nodes are illustrated by white circles, master nodes are illustrated by darkened circles, slave candidate nodes are illustrated by white circles surrounded by another circle, master candidate nodes are illustrated by a darkened circle surrounded by another circle, and the heavy darkened lines connecting nodes illustrate logical links between nodes. FIG. 25A illustrates a tree of candidate nodes in the process of being built. The second intermediate master node selects nodes 2510 and 2520 as candidate nodes in its piconet and places a reference to these nodes in the TS candidate message before forwarding the message along the MCS path. As illustrated by the logical links out of node 2510, node 2540 selects nodes 2530 and 2550 as candidate nodes to be logically linked to node 2510. Similarly, as illustrated by the logical links out of node 2520, node 2540 selects nodes 2530 and 2540 (i.e. itself) as candidate nodes to be logically linked to node 2520.

FIG. 25B illustrates a complete tree of candidate nodes as illustrated in FIG. 25B each intermediate master node may, select more than one candidate node to be logically linked with each of the existing branches in the tree of candidate nodes. FIG. 25C illustrates a selected branch in the tree of candidate nodes for TS establishment. As will be described in more detail below, TS path establishment where multiple candidate nodes per piconet can be selected is performed in a similar manner to the method described above wherein only a single candidate node is selected. Accordingly, as illustrated in FIG. 25C, the start node (SN) is connected to node 2555 which in turn is connected to node 2560. Node 2560 is connected to node 2565, node 2565 is connected to node 2570, and node 2570 is connected to the end node (EN). Furthermore, FIG. 25C illustrates the alternating of master and slave roles for nodes of the TS. The roles of the TS nodes are indicated with the letters m (master) and s (slave) respectively.

TS Establishment: Start Node Tree Building

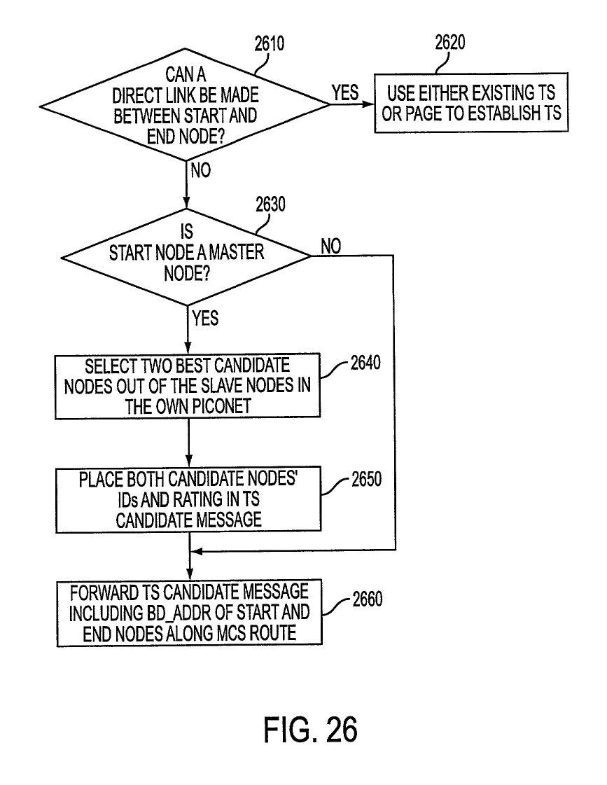

FIG. 26 illustrates the TS candidate tree building phase in a start node in accordance with exemplary embodiments of the present invention. Initially, the start node determines whether a direct link can be made between the start node and the end node (step 2610). If a direct link can be made between the start node and the end node (“Yes” path out of decision step 2610) then the start node will use either the existing TS or page the end node to establish a new TS (step 2620). If, however, a direct link cannot be made between the start node and the end node (“No” path out of decision step 2610) the start node determines whether it is a master node (step 2630). If the start node determines that it is a master node (“Yes” path out of decision step 2630) then the master node selects the two best candidate nodes out of the slave nodes in its piconet based upon their TS rating value (step 2640) and places both candidate nodes' IDs and ratings in the TS candidate message (step 2650).

After the start node has placed both candidate nodes' IDs in the TS candidate message (step 2650) or if the start node is not master node (“No” path out of decision step 2630) then the start node forwards the TS candidate message including the BD_ADDR of the start and end nodes along the MCS route (step 2660). Although the method described above describes the start node selecting the two best candidate nodes, it will be recognized that if the start node cannot find two best candidate nodes, the start node will only select the best candidate node, if any, and place the best candidate node's ID and rating in the TS candidate message. Furthermore, it will be recognized that the method described above can be implemented such that more than two best candidate nodes are selected. However, the more candidate nodes which can be selected increases the complexity of the tree building. In the methods described below for the first intermediate nodes, the subsequent intermediate nodes, and the end node, if a particular node only has one best candidate node to select then that candidate node's ID and rating is placed in the TS candidate message before being forwarded to the next node. In addition, the methods described below can be implemented such that more than two candidate nodes are selected by any particular node in the MCS path.

TS Establishment: First Intermediate Node Tree Building

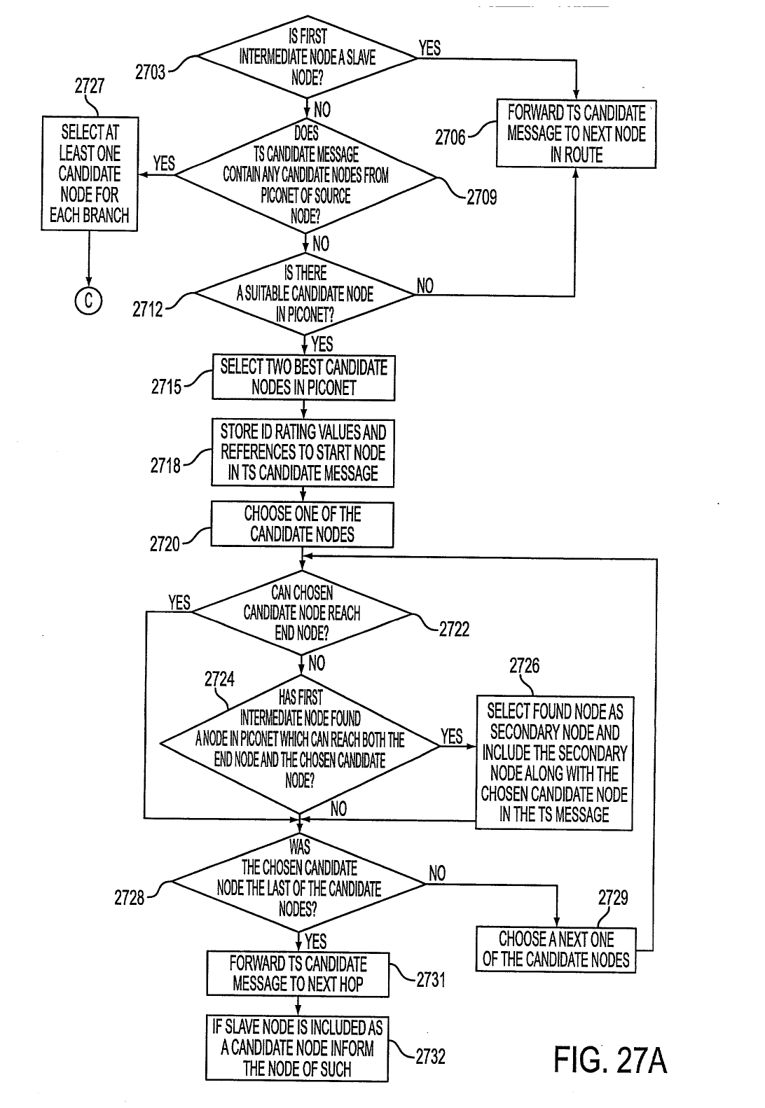

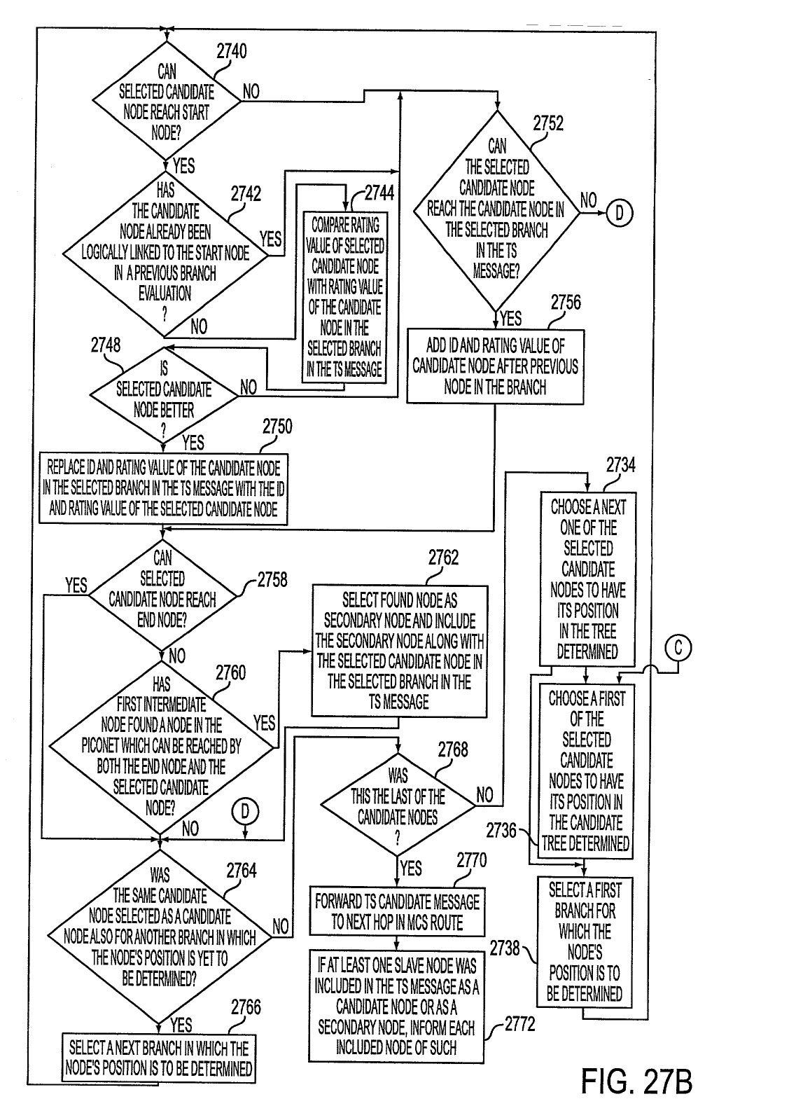

FIGS. 27A and 27B illustrate TS candidate tree building in the first intermediate node in accordance with exemplary embodiments of the present invention. Initially, the first intermediate node determines whether it is a slave node (step 2703). If the first intermediate node is a slave node (“Yes” path out of decision step 2703) then the first intermediate node will forward the TS candidate message to the next node in the route (step 2706). If the first intermediate node is not a slave node (“No” path out of decision step 2703), i.e., the first intermediate node is a master node, the first intermediate node determines whether the TS candidate message contains any candidate nodes from the piconet of the source node (step 2709). If the first intermediate node determines that the TS candidate message does not contain any candidate nodes from the piconet of the source node (“No” path out of decision step 2709) then the first intermediate node determines whether there is a suitable candidate node in the piconet (step 2712). If the first intermediate node determines that there are no suitable candidate nodes in the piconet (“No” path out of decision step 2712) then the first intermediate node forwards the TS candidate message to the next node in the route (step 2706).

If, however, the first intermediate node determines that there are suitable candidate nodes in its piconet (“Yes” path out of decision step 2712) then the first intermediate node selects the two best candidate nodes in the piconet (step 2715) and stores the IDs, rating values and references to the start node for each selected best candidate node in the TS candidate message (step 2718). The first intermediate node then selects one of the candidate nodes (step 2720) and determines whether the chosen candidate node can reach the end node (step 2722). If the chosen node cannot reach the end node (“No” path out of decision step 2722) then it is determined whether the first intermediate node has found a node in its piconet which can reach both the end node and the chosen candidate node (step 2724). If the first intermediate node has found a node in its piconet which can reach both the end node and the chosen node (“Yes” path out of decision step 2724) then the found node is selected as a secondary node and the found node is included along with the chosen candidate node in the TS candidate message (step 2726).

If the chosen node can reach the end node (“Yes” path out of decision step 2722), the first intermediate node has not found a node in its piconet which can reach both the end node and the chosen candidate node (“No” path out of decision step 2724), or after the found node is included as a secondary node in the TS candidate message (step 2726), it is determined whether the chosen candidate node is the last of the candidate nodes (step 2728). If the chosen candidate node is not the last of the candidate nodes (“No” path out of decision step 2728) then the first intermediate node chooses a next one of the candidate nodes (steps 2729) and determines whether the chosen candidate node can reach the end node (step 2722). The process proceeds in accordance with steps 2724-2729 until the last of the candidate nodes have been evaluated.

If the chosen candidate node is the last of the candidate nodes (“Yes” path out of decision step 2728), i.e., all of the candidate nodes have been evaluated, then the first intermediate node forwards the TS candidate message to the next hop (step 2731) and if a slave node is included as a candidate node the first intermediate node informs the slave node of such (step 2732).

If the TS candidate message contains candidate nodes from the piconet of the source node (“Yes” path out of decision step 2709) then the first intermediate node selects at least one candidate node for each branch of the candidate nodes from the piconet of the source node (step 2727). The selected node(s) are then compared, based upon their TS rating values, with the candidate nodes in the TS candidate message in order to have their positions in the tree of candidate nodes determined (steps 2740-2768).

A first of the selected candidate nodes is chosen to have its position in the candidate tree determined (step 2736) and a first branch for which the chosen node's position is to be determined is selected (step 2738). It is then determined whether the selected candidate node can reach the start node (step 2740). If the selected candidate node can reach the start node (“Yes” path out of decision step 2740) then it is determined whether the candidate node has already been logically linked to the start node in a previous branch evaluation (step 2742). If the candidate node has not already been logically linked to the start node in a previous branch evaluation (“No” path out of decision step 2742) then the rating value of the selected candidate node is compared with the rating value of the candidate node in the selected branch in the TS candidate message (step 2744). Next it is determined whether the selected candidate node is better than the candidate node in the selected branch in the TS candidate message (step 2748). If the selected candidate node is better than the candidate node in the selected branch in the TS candidate message (“Yes” path out of decision step 2748) then the ID and rating value of the candidate node in the selected branch in the TS candidate message is replaced with the ID and rating value of the selected candidate node (step 2750).

If the selected candidate node cannot reach the start node (“No” path out of decision step 2740), the candidate node has already been logically linked to the start node in a previous branch evaluation (“Yes” path out of decision step 2742), or the selected candidate node is not better than the candidate node in the selected branch in the TS candidate message (“No” path out of decision step 2748) then it is determined whether the selected candidate node can reach the candidate node in the selected branch in the TS candidate message (step 2752). If the selected candidate node can reach the candidate node in the selected branch in the TS candidate message (“Yes” path out of decision step 2752) then the ID and rating value of the candidate node is added to the TS candidate message after the previous node in the branch (step 2756).

After the ID and rating value of the candidate node is added to the TS candidate message (step 2756) or after the ID and rating value of the selected candidate node replaces the ID and rating value of the candidate node in the selected branch in the TS candidate message (step 2748), it is determined whether the selected candidate node can reach the end node (step 2758). If the selected candidate node cannot reach the end node (“No” path out of decision step 2758) then it is determined whether the first intermediate node has found a node in the piconet which can be reached by both the end node and the selected candidate node (step 2760). If the first intermediate node has found a node in the piconet which can be reached by both the end node and the selected candidate node (“Yes” path out of decision step 2760) then the found node is selected as a secondary node and the found node is included along with the selected candidate node in the selected branch in the TS candidate message (step 2762).

If the selected candidate node cannot reach the candidate node in the selected branch in the TS message (“No” path out of decision step 2752), the selected candidate node can reach the end node (“Yes” path out of decision step 2758), the first intermediate node has not found a node in the piconet which can be reached by both the end node and the selected candidate node (“No” path out of decision step 2760), or after the selected found node has been included in the TS candidate message as a secondary node (step 2762), it is determined whether the same candidate node was selected as a candidate node for another branch in which the node's position has yet to be determined (step 2764). If the same candidate node was selected as a candidate node for another branch in which the node's position has yet to be determined (“Yes” path out of decision step 2764) then a next branch is selected in which the node's position is to be determined (step 2766), it is determined whether the candidate node can reach the start node (step 2740) and processing proceeds as described above.

If the same candidate node was not selected as a candidate node for another branch in which the node's position has yet to be determined (“No” path out of decision step 2764) then it is determined whether this was the last of the candidate nodes (step 2768). If this was the last of the candidate nodes (“Yes” path out of decision step 2768) then the TS candidate message is forwarded to the next hop in the MCS route (step 2770) and if at least one slave node was included in the TS candidate message as a candidate node or as a secondary node, each of the included nodes are informed of such inclusion (step 2772). If, however, this was not the last candidate node (“No” path out of decision step 2768) then a next one of the selected candidate nodes is chosen to have its position in the tree determined (step 2734), a first branch for which the node's position is to be determined is selected (step 2738) and the processing proceeds as described above.

TS Establishment: Subsequent Intermediate Node Tree Building

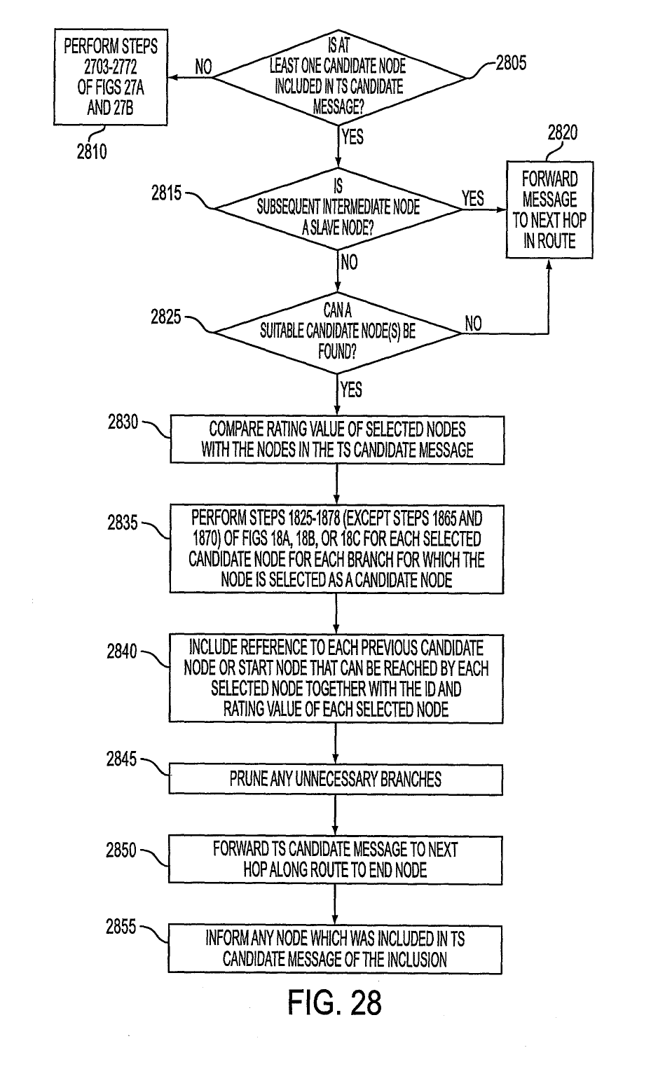

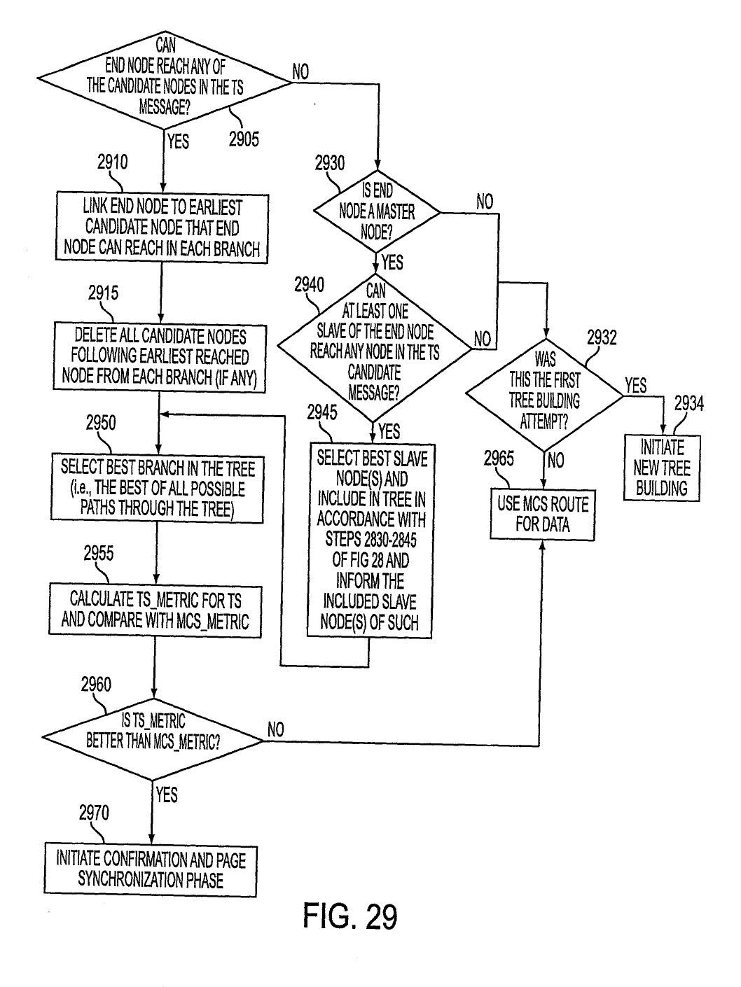

FIG. 28 illustrates TS candidate tree building in a subsequent intermediate node in accordance with exemplary embodiments of the present invention. The subsequent intermediate node initially determines whether there is at least one candidate node included in the TS candidate message (step 2805). If the subsequent intermediate node determines that there is not at least one candidate node included in the TS candidate message (“No” path out of decision step 2805) then the subsequent intermediate node acts and performs steps 2703-2772 described above in connection with FIGS. 27A and 27B (step 2810), i.e., the subsequent intermediate node acts as a first intermediate node. If, however, there is at least one candidate node included in the TS candidate message (“Yes” path out of decision step 2805) then the subsequent intermediate node determines whether it is a slave node (step 2815). If the subsequent intermediate node is a slave node (“Yes” path out of decision step 2815) then the subsequent intermediate node will forward the TS candidate message to the next hop in the MCS route (step 2820). If the subsequent intermediate node is not a slave node (“No” path out of decision step 2815), i.e., that the subsequent intermediate node is a master node, the subsequent intermediate node determines whether a suitable candidate node(s) can be found (step 2825). If the subsequent intermediate node determines that no suitable candidate node(s) can be found (“No” path out of decision step 2825) then the subsequent intermediate node will forward the TS candidate message to the next hop in the MCS route (step 2820).

If, however, the subsequent intermediate node can find suitable candidate node(s) (“Yes” path out of decision step 2825) then the subsequent intermediate node compares the TS rating value of the selected node(s) with the TS rating value of the node(s) in the TS candidate message (step 2830). The subsequent intermediate node then evaluates each selected candidate node and determines its position in each of the branches for which the node is selected as a candidate node (step 2835). In one embodiment, the embodiment in which the flowchart of FIG. 18A is used, this involves performing the steps 1825-1878 (except steps 1865 and 1870) described above in connection with FIG. 18A for each selected candidate node for each branch for which it is selected as a candidate node. In another embodiment, the embodiment in which the flowchart of FIG. 18B is used, this involves performing the steps 1825-1878 (except steps 1865 and 1870) described above in connection with FIG. 18B for each selected candidate node for each branch for which the node is selected as a candidate node. In yet another embodiment, the embodiment in which the flowchart of FIG. 18C is used, this involves performing the steps 1825-1878 (except steps 1865 and 1870) described above in connection with FIG. 18C for each selected candidate node for each branch for which the node is selected as a candidate node. The process of determining the candidate nodes' positions in the tree also serves to eliminate any redundant or unnecessary candidate nodes in the branches of the tree (step 2835). Once the subsequent intermediate node has eliminated any unnecessary nodes in each branch of the tree (step 2835) the subsequent intermediate node will include a reference to each previous candidate node or the start node that can be reached by each selected candidate node together with the ID and rating value of each selected candidate node in the TS candidate message (step 2840). The subsequent intermediate node will then prune any unnecessary branches in the TS candidate tree (step 2845). Selection criteria for branches to be pruned could be, e.g., the worst branches in terms of compound or average rating value, offered capacity or the ones considered to have the least chance to reach all the way to the end node. Another way would be to prune the tree in a way which keeps branches that diverted early from the rest of the tree in order to provide redundancy in terms of long alternative branches. After pruning any unnecessary branches, the subsequent intermediate node will then forward the TS candidate message to the next hop along the MCS route to the end node (step 2850). The subsequent intermediate node will inform any node which was included in the candidate message of its inclusion (step 2855).

TS Establishment: End Node Tree Building

FIG. 29 illustrates TS candidate tree building in an end node in accordance with exemplary embodiments of the present invention. Initially, the end node determines whether it can reach any of the candidate nodes preceding the last candidate node in any branch of the tree in the TS candidate message (step 2905). If the end node can reach any of the candidate nodes preceding the last candidate node in any branch (“Yes” path out of decision step 2905) then the end node links to the earliest node in each branch that the end node can reach (step 2910) and deletes all nodes following the earliest reached node from each branch (step 2915).

If the end node cannot reach any of the candidate nodes preceding the last candidate nodes in any branch (“No” path out of decision step 2905) then the end node determines whether it is a master node (step 2930). If the end node is a master node (“Yes” path out of decision step 2930) then the end node determines whether at least one of its slave nodes can reach any of the nodes in the TS candidate message (step 2940). If the end node is not a master node (“No” path out of decision step 2930), or if none of the slave nodes of the end node can reach any of the nodes in the TS candidate message (“No” path out of decision step 2940) then the end node determines whether this was the first tree building attempt (step 2932). If this was the first tree building attempt (“Yes” path out of decision step 2932) then a new tree building is initiated (step 2934). If, however, this was not the first tree building attempt (“No” path out of decision step 2932) then the MCS route is used for the data (step 2965).

If at least one slave node of the end node can reach any of the nodes in the TS candidate message (“Yes” path out of decision step 2940), the best slave node(s) is selected and included in the tree in accordance with steps 2830-2845 of FIG. 28 and any included slave node(s) are informed of such inclusion (step 2945). After all candidate nodes following the earliest reached node is deleted from each branch (step 2915) or after the best slave node(s) is included in the tree (step 2945) then the end node then selects the best branch in the tree, i.e., the best of all possible paths through the tree, by comparing their respective TS_METRICs (step 2950). The TS_METRIC of the selected branch is then compared with the MCS_METRIC of the MCS route (step 2955). If the TS_METRIC is not better than the MCS_METRIC (“No” path out of decision step 2960) then the end node will use the MCS route for the user data (step 2965). If the TS_METRIC is better than the MCS_METRIC (“Yes” path out of decision step 2960) then the end node initiates the confirmation and page synchronization phase of the TS establishment procedure (step 2970).

TS Tree Building: Confirmation and Page Synchronization Phase

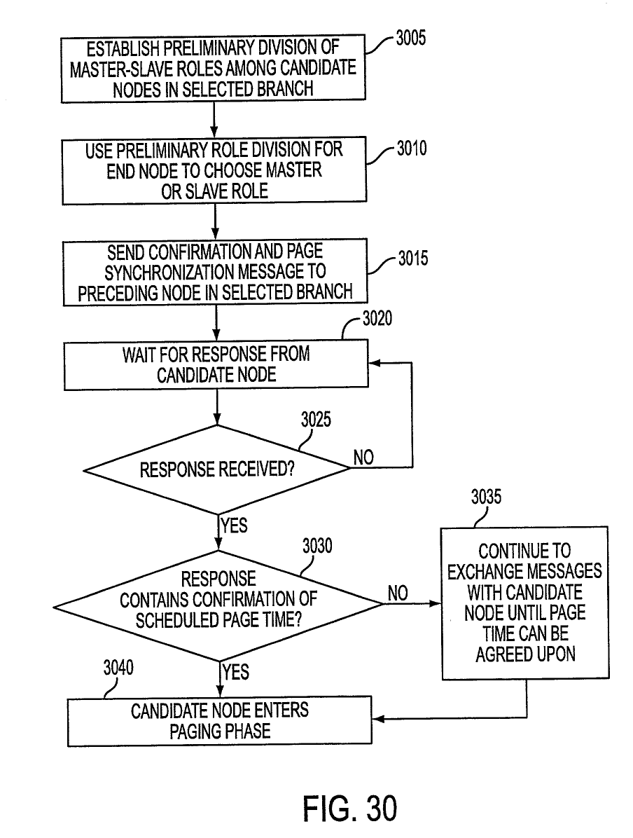

FIG. 30 illustrates an exemplary method for the confirmation and PAGE synchronization phase for TS candidate tree building in accordance with the present invention. Initially, a preliminary division among the master-slave roles among the candidate nodes in the selected branch are established (step 3005). Next the end node chooses to be either a master node or slave node for the TS based upon the preliminary role division for the selected branch (step 3010) and sends confirmation and page synchronization messages to the preceding node in the selected branch (step 3015). The node then waits for a response from the candidate node (step 3020) and determines whether a response has been received (step 3025). If the node determines that no response has been received (“No” path out of decision step 3025) then the node continues to wait for a response from the candidate node (step 3020). If the node determines that a response has been received from the candidate node (“Yes” path out of decision step 3025) then the node determines whether the response contains confirmation of the scheduled page time (step 3030). If the response does not contain a confirmation of the scheduled page time (“No” path out of decision step 3030) then the node continues to exchange messages with the candidate node until a page time can be agreed upon (step 3035). If the response contains a confirmation of the scheduled page time (“Yes” path out of decision step 3035) or after a page time has been agreed upon (step 3035) then the candidate node enters the paging phase (step 3040). The method described above for the synchronization and paging phase will occur for each candidate node in the selected branch, wherein each candidate node performs steps 3015-3040.

TS Tree Building: Paging Phase

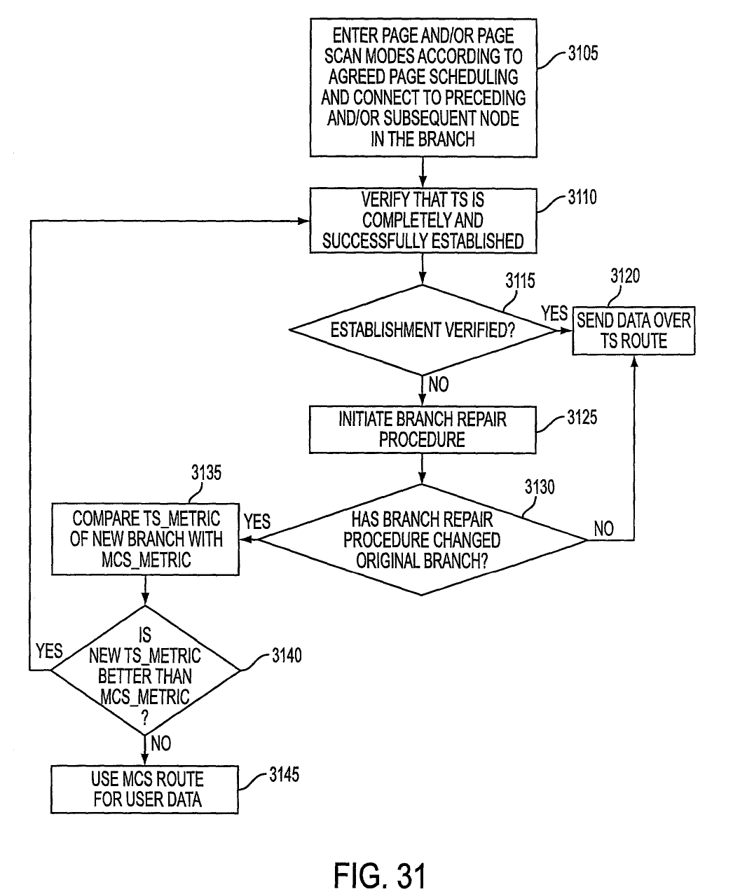

FIG. 31 illustrates an exemplary method for the paging phase in the start node, end node or any candidate nodes in a selected branch in accordance with the present invention. Initially a node enters the page and/or page scan modes according to the agreed upon page schedule and connects to the preceding and/or subsequent node in the branch (step 3105). Next the node verifies that the TS is completely and successfully established (step 3110). If it has been established that the TS is completely and successfully established (“Yes” path out of decision step 3115) then the node begins to send data over the TS route (step 3120). If, however, the node determines that the TS has not been completely and successfully established (“No” path out of decision step 3115) then the node will initiate the branch repair procedure (step 3125) and determine whether the branch repair procedure has changed the structure of the original branch (step 3130). If the node determines that the branch repair procedure has not changed the original branch (“No” path out of decision step 3130) then the node will begin to send data over the TS route (step 3120).

If the node determines that the branch repair procedure has changed the original branch (“Yes” path out of decision step 3130) then the node compares the TS_METRIC of the new branch with the MCS_METRIC of the MCS route (step 3135) and determines whether the new TS_METRIC is better than the MCS_METRIC (step 3140). If it is determined that the new TS_METRIC is not better than the MCS_METRIC (“No” path out of decision step 3140) then the node uses the MCS route to transport the user data (step 3145). If the new TS_METRIC is better than the MCS_METRIC (“Yes” path out of decision step 3140) then the node determines whether the TS has been completely and successfully established (step 3110) and processing proceeds as described above.

The branch repair procedure may or may not be similar to the chain repair procedure described in connection with the TS chain building paging phase. The gaps in the branch could be located in the same way as in the TS candidate chain, i.e. by sending a certain message (e.g., called “branch verification message”) both from the end node and from the start in opposite directions along the branch, collecting information about successful and unsuccessful TS link establishments. The gaps could then be filled out by local branch building, just as in the chain repair case. Another way to repair a branch would be to make use of the alternative branches in the tree, provided that the complete tree structure is known by all nodes in the branch. The complete tree structure could be included in the confirmation and page synchronization messages or in the branch verification messages. When the information about unsuccessful TS link establishments is collected the branch can be repaired by local selections of alternative branches. Since all the nodes in the branch share the same view of the tree structure and they all use the same evaluation algorithm, they would end up with a common view on the alternative branches to be selected.

Another simpler way of repairing a branch would be to select a completely new branch (instead of the failed one) between the end node and the start node. This would probably be done by the end node, which would then initiate the confirmation and page synchronization along the new branch. Another way to enable local branch repairing would be to integrate the paging phase with the confirmation and page synchronization phase and page through the tree sequentially. The branch selection can then be made locally. First the end node selects a branch from itself to the start node. It then schedules a time for the page and performs the page procedure (either as the paging node or as the paged node) to establish the first TS link. If this is successful, the next node along the branch selects the best branch from itself to the start node. This way the TS links are sequentially established along the branch. If a page procedure fails, the node initiating the page scheduling selects an alternative branch to the start node and makes a new attempt. If there is no alternative branches available, the failure is signaled backwards along the established TS links until a node with an available alternative branch is found. Then this node selects an alternative branch to the start node and initiates the sequential TS link establishment along this branch instead. This procedure requires that the candidate nodes store the structure of the part of the tree that was built up to the point when they themselves were included in the tree, i.e., each candidate node has to know all available paths through the tree between itself and the start node. If all other branch repair attempts fail, the last resort is to initiate a new tree building from scratch. This could be done either by the start node or the end node. Regardless of which branch repair procedure that is used, if the node structure of the branch has changed due to the branch repair, the TS_METRIC for the new branch is calculated and compared with the MCS_METRIC. If the TS_METRIC is not better than the MCS_METRIC, the MCS route will be used for the user data and the TS will be torn down.

TS Establishment: Reachability Information Unavailable

The method described above for TS establishment is concerned the situation when the reachability information of each node is available. However, such reachability information may not be available. Accordingly, it would be desirable to perform TS establishment in networks wherein the reachability information is not available. In accordance with exemplary embodiments of the present invention, when reachability information is not available a scheduled, collective reachability check from the start node, and possibly also from the end node, to a number of selected intermediate nodes is performed simultaneously. Then any gap in between the reachable nodes is iteratively filled out, wherein the nodes which perceive the gap act as either the start node or end node and perform the scheduled collective reachability check. This way a “chain of reachability” is created between the start node and the end node.

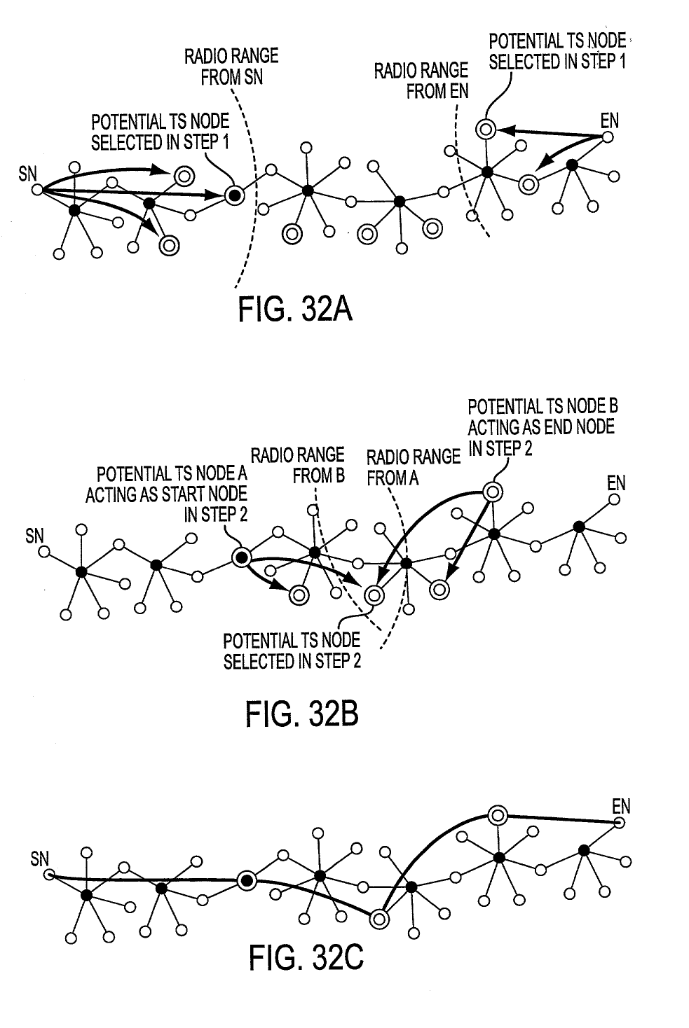

FIGS. 32A-32C illustrates several iterations of the scheduled collective reachability check. In FIGS. 32a-32c, slave nodes are illustrated as a white circle, master nodes as a darkened circle, potential TS slave nodes by a white circle surrounded by a dark circle, potential TS master nodes by a dark circle surrounded by another dark circle, slave nodes listening for reachability check messages by a white circle surrounded by a lighter circle, master nodes listening for reachability check messages by a darkened circle surrounded by a lighter circle, the lighter arrows illustrating reachability check messages to the receiving node and the darkened heavy lines illustrate the reachability chain. As illustrated in FIG. 32a, the start node (SN) and the end node (EN) send a reachability check message to all the nodes that have been informed to listen for the reachability check message at a certain time and frequency. As illustrated in FIG. 32a, none of the listening nodes can be reached from both the start node and the end node, and hence, there is a gap in the chain. FIG. 32b illustrates the second iteration of the reachability check which is used to fill in the above-mentioned gap. Accordingly, the potential TS node selected in the first iteration illustrated in FIG. 32a, acts as the start node or end node and sends reachability check messages. As illustrated in FIG. 32b, the second iteration of the reachability check messages results in a potential TS node selected such that there are only three nodes between the start node and the end node. FIG. 32c illustrates the reachability chain between the start node and the end node including the above-mentioned three intermediate nodes.

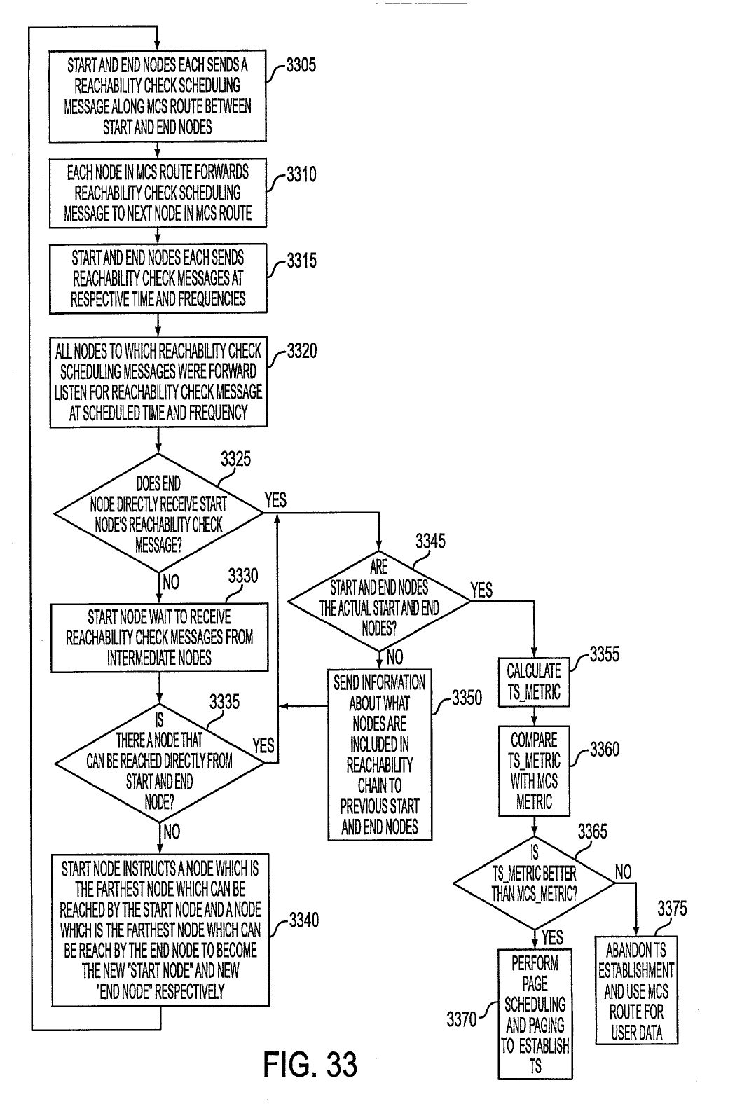

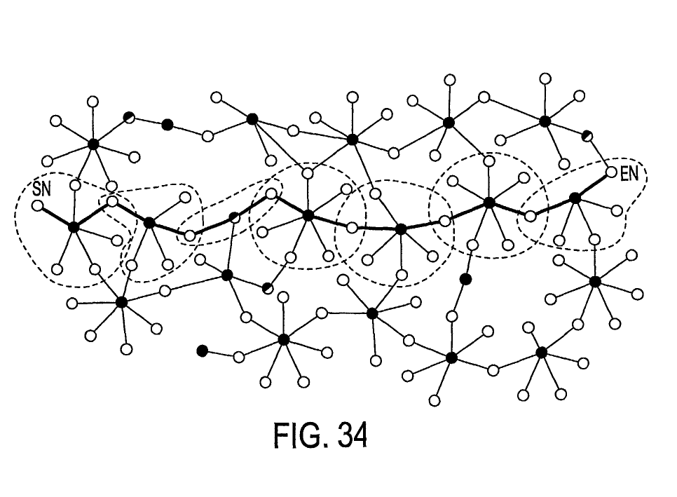

FIG. 33 illustrates an exemplary method for performing a reachability check in accordance with the present invention. Initially the start and end nodes each sends a reachability check scheduling message along the MCS route between the start and end nodes (step 3305). The reachability check scheduling message includes information about the time and frequency of a subsequent reachability check message (which may be e.g. an inquiry message, a page message including the DAC of the sending node, or a dedicated message). The reachability check scheduling messages are forwarded to all the nodes in the MCS route between the start node and the end node (step 3310). In one embodiment the master nodes in the MCS route also forward the reachability check scheduling message to selected slave nodes that are not part of the MCS route. The start node and the end node each then sends a reachability check message at the respective scheduled times and frequencies (step 3315). All the nodes to which the reachability check scheduling message were forwarded will then listen for the reachability check messages at the scheduled times and frequencies (step 3320), unless prevented by matters of higher priority, e.g. SCO timeslots. Next it is determined whether the end node has directly received the start node's reachability check message (step 3325). If the end node does not directly receive the start node's reachability check message (“No” path out of decision step 3325) then the start node waits to receive reachability check messages from intermediate nodes (step 3330) and determines if there are any nodes that can be reached directly from the start and end nodes (step 3335). The response messages are sent via the MCS, whereas the reachability check messages themselves are transmitted to be received directly (without intermediate hops) by any of the listening nodes. All responses, both responses to the reachability check message from the start node and responses to the reachability check messages from the end node are sent to the start node. Hence, the address of the start node has to be included in the reachability check scheduling message from the end node.

If there are no nodes that can be reached directly from the start and end nodes (“No” path out of decision step 3335) then the start node instructs a node which is the farthest node away from the start node which can be reached by the start node and a node which is farthest from and can be reached by the end node to become the new “start node” and the new “end node” respectively (step 3340). The new “start node” and the new “end node” then perform the reachability check beginning with step 3305 and processing proceeds as described above with the new “start node” and the new “end node”.

If the end node directly receives the start node's reachability check message (“Yes” path out of decision step 3325) or if there is a node that can be reached directly from the start and end nodes (“Yes” path out of decision step 3335) then it is determined whether the start and end nodes are the actual start and end nodes (step 3345). If the start and end nodes are not the actual start and end nodes (“No” path out of decision step 3345) then information about which nodes are included in the reachability chain are sent to the previous start and end nodes (step 3350). These previous start and end nodes determine whether they are the actual start and end nodes (step 3345) and processing proceeds as described above. This way the information about the nodes in the reachability chain is iteratively built up and eventually passed all the way to the actual start and end nodes.

If the start and end nodes are the actual start and end nodes (“Yes” path out of decision step 3345) then a TS_METRIC is calculated for the potential TS (step 3355) and compared with the MCS_METRIC (step 3360). If the TS_METRIC is not better than the MCS_METRIC (“No” path out of decision step 3365), the TS establishment is abandoned (step 3375), a message indicating this may be sent from the start node to the end node, and the MCS route will be used for user data transfer. Otherwise, if the TS_METRIC is better than the MCS_METRIC (“Yes” path out of decision step 3365), then the page scheduling and paging can take place in order to actually establish the TS (step 3370). This can be done in a similar way as in the TS chain building described previously, although it is now initiated from the start node instead of the end node. That is the start node establishes a preliminary division of master and slave nodes in the potential TS. Then paging times are scheduled and pages executed for each respective node pair along the potential TS until the TS is established. If the paging procedure fails somewhere along the potential TS, similar chain repair procedures as previously described in connection with the TS chain building can be performed, although the local chain building in this case would use reachability checks instead of already available reachability information. The creation of the reachability chain may also be restarted from scratch. If repair procedures (of any kind) have changed the original reachability chain, the TS_METRIC associated with the new reachability chain is calculated and compared with the MCS_METRIC in order to determine whether to establish the TS (based on the new reachability chain) or abandon the TS establishment and use the MCS route for transfer of user data.

In another embodiment the above-described procedure to build a reachability chain is somewhat modified. Then the reachability checks are preformed only in the direction from the start node. The start node would then only collect responses triggered by its own reachability check message. Since the end node did not send a reachability check message, none of the responding nodes will report that it can hear both the start node and the end node. Hence, if the end node cannot be reached directly, the node that is the farthest away from the start node of the nodes that can reached by the start node is instructed to perform the next iteration of reachability checks. Each iteration is performed with a new node acting as start node and the original end node acting as end node. Apart from the one-sidedness of the reachability checks the selection of potential TS nodes proceeds just as in the embodiment with reachability checks in both directions. When the reachability chain is completed, the subsequent procedures, i.e., comparison of the potential TS and the MCS route, the page scheduling, the paging procedures, the possible TS verification and chain repair procedures are exactly the same as in the embodiment with reachability checks in both directions.

In both these embodiments, i.e., the one with reachability checks in both directions and the one with reachability checks only in the direction from the start node, the TS nodes are selected based only on the number of hops from the start node (or the node acting as start node in later iteration) or the end node (or the node acting as end node in a later iteration). To improve the quality of the resulting TS, the information which the TS node selection is based on could possibly be extended. For example, the responding nodes could include information such as the offered capacity and their number of piconet memberships into their response messages.

The present invention has been described with reference to several exemplary embodiments. However, it will be readily apparent to those skilled in the art that it is possible to embody the invention in specific forms other than those of the exemplary embodiments described above. This may be done without departing from the spirit of the invention. These exemplary embodiments are merely illustrative and should not be considered restrictive in any way. In particular it should be noted that the described procedures for TS establishment may be used also in Bluetooth scatternet scenarios where there is no distinction between MCS and TSs. Even in such a scenario two nodes connected to the same scatternet may use the TS establishment procedures (with the exception that already established TS links can not be used instead of new links, since there is no distinction between TS links and other links) in order to optimize the communication between themselves. The scope of the invention is given by the appended claims, rather than the preceding description, and all variations and equivalents which fall within the range of the claims are intended to be embraced therein.

What is claimed is:

1. A method for routing information in an ad-hoc network, wherein the adhoc network includes a plurality of sub-networks, the method comprising the steps of:
forming another plurality of sub-networks using the nodes of the plurality of sub-networks, wherein a master of each of the another plurality of sub-networks includes information regarding each slave of its respective sub-network, wherein the another plurality of sub-networks is formed to minimize the number of connections between the another plurality of sub-networks, and whereby the another plurality of sub-networks form a maximum connectivity network;
sending information from a first node to a second node using the maximum connectivity network;
establishing a traffic network between the first node and the second node; and
moving the information sent between the first node and the second node from the maximum connectivity network to the established traffic network.

2. The method of claim 1, wherein the traffic network includes nodes of the maximum connectivity network.

3. The method of claim 1, wherein nodes which are members of the traffic network suspend participation in their respective one of the another plurality of sub-networks when participating in the traffic network.

4. The method of claim 1, wherein the traffic network includes more than one master node.

5. The method of claim 4, wherein each of the sub-networks in the plurality of sub-networks and the another plurality of sub-networks include only one master node for each sub-network.

6. The method of claim 1, wherein the traffic network operates according to a high-speed mode.

7. The method of claim 1, wherein the forming step comprises the steps of:
paging, from the first node, the master node with the highest number of slave nodes among all master nodes which are detected by the first node, wherein the master node is not a member of the same sub-network as the first node;
sending a request from the first node to the master node to become a member of the master node's sub-network; and
joining the master node's sub-network if the request is granted.

8. The method of claim 7, wherein if the request is not granted performing the steps of:
paging, from the first node, another master node with the next highest number of slave node's among all master node's which are detected by the first node;
sending a request from the first node to the another master node to become a member of the master node's sub-network; and
joining the another master node's sub-network if the request is granted.

9. The method of claim 7, wherein the first node is in an idle state.

10. The method of claim 7, further comprising the steps of:
paging, from the first node, a slave node with the highest identification number among all slave nodes which are detected by the first node, wherein the slave node is not a member of the same sub-network as the first node;
requesting the identification number of the slave node's master node;
sending a request from the first node to the slave node's master node to become a member of the sub-network of the slave node's master node; and
joining the sub-network of the slave node's master node if the request is granted.

11. The method of claim 1, wherein the forming step comprises the steps of:
sending a message from a slave node informing the slave node's master node of the number of nodes connected in detected sub-networks and the identification number of the nodes in the detected sub-networks, wherein the slave node is not a member of the detected sub-network; and
paging, by the slave node, a node in the detected sub-networks if the slave node's master node requests the slave node to perform the paging.

12. The method of claim 1, wherein the forming step comprises the steps of:
paging, from the first node, a master node, wherein the first node and the master node are not members of the same sub-networks and wherein the first node is a master node;
obtaining the addresses of all slave nodes of the paged master node; and
merging sub-networks if the first node can reach all of the slave nodes of the paged master node.

13. The method of claim 12, further comprising the steps of:
reporting to the first node from another node identification of all nodes which can be reached from the another node, wherein the first node and the another node are members of the same network and the first node is a master of the subnetwork; and
making the another node the master of the sub-network if the another node reaches more nodes than the first node.

14. The method of claim 1, wherein the step of establishing a traffic network comprises the steps of:
paging from the first node to the second node over the maximum connectivity network; and
initiating from the second node a scanning procedure for a first traffic network between the first node and second node, wherein information sent between the first node and the second node is moved to the traffic network if establishment of the traffic network is successful.

15. The method of claim 14, wherein if the traffic network establishment fails, performing the steps of:
searching for the second node in any established traffic network;
using one of the any established traffic networks to communicate information between the first node and the second node if the one of the any established traffic route networks has less intermediate nodes than the route over the maximum connectivity network.

16. The method of claim 15, wherein if the traffic network has more intermediate nodes than the route over the maximum connectivity network or if the second node is not found in any established traffic network, performing the steps of:
sending, from the second node to the first node, a list of candidate nodes including all intermediate nodes in the route over the maximum connectivity network;
adding in each master node along the route over the maximum connectivity network additional candidate nodes;
paging, from the first node, a first node in the list of candidate nodes, wherein the first node in the list of candidate nodes is the closest node in the list of candidate nodes to the second node;
setting up a connection between the first node and the first node in the list of candidate nodes if the first node in the list of candidate nodes responds to the page;
paging from the first node in the list of candidate nodes to the second node; and
establishing a traffic network to communicate information between the first node and the second node including the first node in the list of candidate nodes if the established traffic route network has less intermediate nodes than the route over the maximum connectivity network.

17. The method of claim 1, wherein the step of establishing a traffic network comprises the steps of:
selecting a first candidate node;
determining if the first candidate node can reach the first node or any other candidate nodes;
establish a candidate node rating if the candidate node can reach the first node or any other candidate nodes;
determining if the first candidate node is a member of more than a predetermined number of sub-networks; and
adding the first candidate node and the associated candidate node rating to a candidate node list if the first candidate node is a member of less than the predetermined number of sub-networks.

18. The method of claim 17, further comprising the steps of:
selecting a second candidate node;
determining if the second candidate node can reach the first node or any other candidate nodes;
establish a candidate node rating if the candidate node can reach the first node or any other candidate nodes;
determining if the second candidate node is a member of more than a predetermined number of sub-networks; and
adding the second candidate node and the associated candidate node rating to a candidate node list if the second candidate node is a member of less than the predetermined number of sub-networks.

19. The method of claim 1, wherein the step of establishing a traffic network comprises the steps of:
selecting in the first node a first candidate node;
including the first candidate node to a candidate node list; and
forwarding the candidate node list to a next node in a route in the maximum connectivity network between the first node and a second node.

20. The method of claim 19, further comprising the steps of:
determining in the next node whether a second candidate node which meets a predetermined criteria is connected in a same sub-network as the next node;
comparing the second candidate node with the first candidate node if the second candidate node which meets the predetermined criteria is connected in the same sub-network as the next node;
replacing the first candidate node with the second candidate node in the candidate node list if the second candidate node can reach the first node and the second node; and
forwarding the candidate node list to another next node in the route in the maximum connectivity network.

21. The method of claim 20, further comprising the steps of:
adding the second candidate node to the candidate node list if the second candidate node can reach the first candidate node and the second node.

22. The method of claim 20, further comprising the steps of:
selecting by the another candidate node an earliest candidate node in the list of candidate nodes that can be reached by the another candidate node;
determining if the another candidate node has a greater rating than a node which follows the earliest candidate node in the candidate node list; and
replacing the node which follows the earliest candidate node and all subsequently following candidate nodes with the another candidate node in the candidate node list if the another candidate node has a greater rating than the node which follows the earliest node.

23. The method of claim 22, further comprising the steps of:
determining the earliest node in the candidate node list which can be reached by the second node;
deleting all nodes following the earliest node which can be reached by the second node from the candidate node list; and
determining if the remaining path of nodes in the candidate node list between the first node and the second node is better than the path in the maximum connectivity network between the first node and the second node.

24. The method of claim 19, further comprising the steps of:
sending from the second node a page and synchronization message to a preceding node in the candidate node list;
entering a paging phase with the preceding node if the preceding node responds to the second node with a confirmation of a scheduled page time contained in the page and synchronization message.

25. The method of claim 1, wherein the step of establishing a traffic network between the first node and the second node comprises the steps of:
determining whether the first node has information regarding other nodes of the maximum connectivity network that the first node can reach.

26. The method of claim 26, wherein other nodes of the maximum connectivity network can be reached by the first node if the other nodes are within radio range of the first node.

27. The method of claim 25, wherein the determining step is performed for each node of the maximum connectivity network.

28. The method of claim 25, wherein if it is determined that the first node does not have information regarding other nodes of the maximum connectivity network that the first node can reach then performing the steps of:
broadcasting a first message from the first node and the second node, wherein the message includes information regarding a time and frequency at which a second message will be transmitted by the first and the second nodes;
returning, in response to receipt of the second message, a third message to the first node; and
determining whether there is a node which can be reached directly from the first and second nodes.

29. The method of claim 28, wherein if it is determined that there is not a node which can be reached by both the first and second node, performing the steps of:
instructing, by the first node, another first node to broadcast another first message which includes information regarding a time and frequency at which another second message will be transmitted by the another first node, wherein the another first node is the farthest node which can be reached directly from the first node; and
instructing, by the first node, another second node to broadcast another first message which includes information regarding a time and frequency at which another second message will be transmitted by the another second node, wherein the another second node is the farthest node which can be reached directly from the second node.

30. The method of claim 29, wherein if it is determined that there is a node which can be reached directly by both the another first node and the another second node, then calculating a metric for a traffic network between the first node and the second node, wherein the traffic network includes the node which can be reached directly by both the another first node and the another second node, the another first node and the another second node.

31. A method for forming a plurality of sub-networks in an ad-hoc network comprising the steps of:
paging, from a first node, a master node with the highest number of slave nodes among all master nodes which are detected by the first node, wherein the master node is not a member of the same sub-network as the first node;
sending a request from the first node to the master node to become a member of the master node's sub-network; and
joining the master node's sub-network if the request is granted.

32. The method of claim 31, wherein if the request is not granted performing the steps of:
paging, from the first node, another master node with the next highest number of slave node's among all master node's which are detected by the first node;
sending a request from the first node to the another master node to become a member of the master node's sub-network; and
joining the another master node's sub-network if the request is granted.

33. The method of claim 31, wherein the first node is in an idle state.

34. The method of claim 31, further comprising the steps of:
paging, from the first node, a slave node with the highest identification number among all slave nodes which are detected by the first node, wherein the slave node is not a member of the same sub-network as the first node;
requesting the identification number of the slave node's master node;
sending a request from the first node to the slave node's master node to become a member of the sub-network of the slave node's master node; and
joining the sub-network of the slave node's master node if the request is granted.

35. A method for forming a plurality of sub-networks in an ad-hoc network comprising the steps of:
sending a message from a slave node informing the slave node's master node of the number of nodes connected in detected sub-networks and the identification number of the nodes in the detected sub-networks, wherein the slave node is not a member of the detected sub-network; and
paging, by the slave node, a node in the detected sub-networks if the slave node's master node requests the slave node to perform the paging.

36. A method for forming a plurality of sub-networks in an ad-hoc network comprising the steps of:
paging, from a first node, a master node, wherein the first node and the master node are not members of the same sub-networks and wherein the first node is a master node;
obtaining the addresses of all slave nodes of the paged master node; and
merging sub-networks if the first node can reach all of the slave nodes of the paged master node.

37. The method of claim 36, further comprising the steps of:
reporting to the first node from another node identification of all nodes which can be reached from the another node, wherein the first node and the another node are members of the same network and the first node is a master of the subnetwork; and
making the another node the master of the sub-network if the another node reaches more nodes than the first node.

38. A method for establishing a traffic route network in an ad-hoc network including a plurality of sub-networks, the method comprising the steps of:
paging from a source node to a destination node over the ad-hoc network;
initiating from the destination node a scanning procedure for a first traffic route network between the source node and destination node; and
using the traffic route network to communicate information between the source node and the destination node if the traffic route network establishment is successful.

39. The method of claim 38, wherein if the traffic route network establishment fails, performing the steps of:
searching for the destination node in any established traffic route network;
using one of the any established traffic route networks to communicate information between the source node and the destination node if the one of the any established traffic route networks has less intermediate nodes than the route over the ad-hoc network.

40. The method of claim 39, wherein if the traffic route network has more intermediate nodes than the route over the ad-hoc network or if the destination node is not found in any established traffic route network, performing the steps of:
sending, from the destination node to the source node, a list of candidate nodes including all intermediate nodes in the route over the ad-hoc network;
adding in each master node along the route over the ad-hoc network additional candidate nodes;
paging, from the source node, a first node in the list of candidate nodes, wherein the first node is the closest node in the list of candidate nodes to the destination node;
setting up a connection between the source node and the first node if the first node responds to the page;
paging from the first node to the destination node; and
establishing a traffic route network to communicate information between the source node and the destination node including the first node if the established traffic route network has less intermediate nodes than the route over the ad-hoc network.

41. A method for establishing a traffic route network in an ad-hoc network including a plurality of sub-networks, the method comprising the steps of:
selecting a first candidate node;
determining if the first candidate node can reach a source node or any other candidate nodes;
establish a candidate node rating if the candidate node can reach the source node or any other candidate nodes;
determining if the first candidate node is a member of more than a predetermined number of sub-networks; and
adding the first candidate node and the associated candidate node rating to a candidate node list if the first candidate node is a member of less than the predetermined number of sub-networks.

42. The method of claim 41, further comprising the steps of:
selecting a second candidate node;
determining if the second candidate node can reach a source node or any other candidate nodes;
establish a candidate node rating if the candidate node can reach the source node or any other candidate nodes;
determining if the second candidate node is a member of more than a predetermined number of sub-networks; and
adding the second candidate node and the associated candidate node rating to a candidate node list if the second candidate node is a member of less than the predetermined number of sub-networks.

43. A method for establishing a traffic route network in an ad-hoc network including a plurality of sub-networks, the method comprising the steps of:
selecting in a source node a first candidate node;
including the first candidate node to a candidate node list; and
forwarding the candidate node list to a next node in a route in the ad-hoc network between the source node and a destination node.

44. The method of claim 43, further comprising the steps of:
determining in the next node whether a second candidate node which meets a predetermined criteria is connected in a same sub-network as the next node;
comparing the second candidate node with the first candidate node if the second node which meets the predetermined criteria is connected in the same subnetwork as the next node;
replacing the first candidate node with the second candidate node in the candidate node list if the second candidate node can reach the source node and the destination node; and
forwarding the candidate node list to another next node in the route in the ad-hoc network.

45. The method of claim 44, further comprising the steps of:
adding the second candidate node to the candidate node list if the second candidate node can reach the first candidate node and the destination node.

46. The method of claim 44, further comprising the steps of:
selecting by the another candidate node an earliest candidate node in the list of candidate nodes that can be reached by the another candidate node;
determining if the another candidate node has a greater rating than a node which follows the earliest candidate node in the candidate node list; and
replacing the node which follows the earliest candidate node and all subsequently following candidate nodes with the another candidate node in the candidate node list if the another candidate node has a greater rating than the node which follows the earliest node.

47. The method of claim 46, further comprising the steps of:
determining the earliest node in the candidate node list which can be reached by the destination node;
deleting all nodes following the earliest node which can be reached by the destination node from the candidate node list; and
determining if the remaining path of nodes in the candidate node list between the source node and the destination node is better than the path in the adhoc network between the source node and the destination node.

48. The method of claim 43, further comprising the steps of:
sending from a destination node a page and synchronization message to a preceding node in the candidate node list;
entering a paging phase with the preceding node if the preceding node responds to the destination node with a confirmation of a scheduled page time contained in the page and synchronization message.
